(19) United States
(12) Patent Application Publication
(10) Pub. No.: US 2013/0281276 A1
(43) Pub. Date: Oct. 24, 2013

(54) ELECTRICALLY CONDUCTIVE MEMBER, PROCESS CARTRIDGE AND ELECTROPHOTOGRAPHIC APPARATUS

(71) Applicant: CANON KABUSHIKI KAISHA, TOKYO (JP)

(72) Inventors: Masahiro Watanabe, Mishima-shi (JP); Kazuhiro Yamauchi, Suntou-gun (JP); Satoru Nishioka, Suntou-gun (JP); Yuichi Kikuchi, Susono-shi (JP)

(21) Appl. No.: 13/919,999

(22) Filed: Jun. 17, 2013

Related U.S. Application Data
(63) Continuation of application No. PCT/JP2012/008052, filed on Dec. 17, 2012.

(30) Foreign Application Priority Data
Dec. 26, 2011 (JP) 2011-284451

(51) Int. Cl. B05C 1/08

(52) U.S. Cl. CPC G03G 15/751
USPC 492/18

(57) ABSTRACT

An electrically conductive member for electrophotography is provided which has an electrically conductive mandrel and an electrically conductive layer on the peripheral surface of the mandrel; the electrically conductive layer containing a binder resin having as an ion exchange group a sulfo group or a quaternary ammonium salt group in the molecule and an ion with a polarity opposite to that of the ion exchange group; the binder resin further having any structure selected from the group consisting of structures represented by formulas (1)-1 to (1)-3, and any structure selected from the group consisting of structures represented by formulas (2)-1 and (2)-2, and having a molecular structure that prevents any matrix-domain structure from being formed in the electrically conductive layer.

### CROSS-REFERENCE TO RELATED APPLICATIONS

This application is a continuation of International Application No. PCT/JP2012/008052, filed Dec. 17, 2012, which is claims the benefit of Japanese Patent Application No. 2011-284451, filed Dec. 26, 2011.

### BACKGROUND OF THE INVENTION

1. Field of the Invention

The present invention relates to an electrically conductive member, a process cartridge and an electrophotographic apparatus.

2. Description of the Related Art

In electrophotographic image forming apparatus, conductive members are used in various ways, e.g., as a charging roller, a developing roller and a transfer roller. It is preferable for such conductive members to have electrical resistance value in the range of from 10³Ω to 10¹⁰Ω. Hence, for electrically conductive layers the conductive members have, their conductivity is regulated with a conducting agent. Here, the conducting agent is roughly classified into an electron conducting agent as typified by carbon black and an ion conducting agent such as a quaternary ammonium salt compound. These conducting agents each have advantages and disadvantages.

An electrically conductive layer having been made electrically conductive by the electron conducting agent such as carbon black may less cause changes in electrical resistance value depending on its service environments. The electron conducting agent may also not easily bleed to the surface of the electrically conductive layer, and hence there is a fewer possibility that it contaminates the surface of a member with which any conductive member having such an electrically conductive layer comes into contact, e.g., an electrophotographic photosensitive member (hereinafter also “photosensitive member”). However, it is difficult for the electron conducting agent to be uniformly dispersed in a binder resin, and the electron conducting agent tends to aggregate in the electrically conductive layer. Hence, there is a possibility that the electrically conductive layer comes to be locally non-uniform in electrical resistance value.

On the other hand, in an electrically conductive layer having been made electrically conductive by the ion conducting agent, the ion conducting agent is uniformly dispersed in the binder resin compared with the electron conducting agent, and hence the electrically conductive layer can not easily come to be locally non-uniform in electrical resistance. However, the ion conducting agent is, for its ionic conduction performance, susceptible to the water content in the binder resin in a service environment. Hence, such an electrically conductive layer having been made electrically conductive by the ion conducting agent increases in electrical resistance value in a low-temperature and low-humidity environment (temperature 15° C. and relative humidity 10%) (hereinafter often “L/L environment”) and decreases in electrical resistance value in a high-temperature and high-humidity environment (temperature 30° C. and relative humidity 80%) (hereinafter often “H/H environment”). That is, it has a problem that its electrical resistance value has a large environmental dependence. Further, where an electrically conductive member having the electrically conductive layer having been made electrically conductive by the ion conducting agent is left to stand over a long period of time in the state it is kept in contact with other member, the ion conducting agent may soak out of the electrically conductive layer to its surface (hereinafter often “bleeding”).

Japanese Patent Application Laid-open No. 2004-184512 discloses an electrophotographic equipment member having controlled the voltage dependence and environmental dependence of its electrical resistance. Stated specifically, it is proposed to form the electrophotographic equipment member by using a semiconductive composition which contains a binder polymer having in the molecular structure at least one of a sulfonic acid group and a sulfonic acid metal salt structure and a conductive polymer having a surfactant structure formed by using a surface-active agent having a sulfonic acid group in the molecular structure.

### SUMMARY OF THE INVENTION

The present inventors have made studies on the electrophotographic equipment member according to Japanese Patent Application Laid-open No. 2004-184512. As the result, they have recognized that there is still room for improvement on how to reduce the dependence of electrical resistance on environmental variations.

Accordingly, the present invention is directed to providing an electrically conductive member for electrophotography that can not easily vary in electrical resistance value even in various environments and also can not easily cause any bleeding of the conducting agent even during its long-term contact with other members.

Further, the present invention is directed to providing an electrophotographic apparatus that can stably form high-grade electrophotographic images.

According to one aspect of the present invention, there is provided an electrically conductive member for electrophotography, comprising a conductive substrate and an electrically conductive layer provided on the peripheral surface thereof, wherein: the electrically conductive layer contains a binder resin having as an ion exchange group a sulfo group or a quaternary ammonium salt group in the molecule thereof, and an ion with a polarity opposite to that of the ion exchange group; and wherein: the binder resin has any structure selected from the group consisting of structures represented by formulas (1)-1 to (1)-3, and any structure selected from the group consisting of structures represented by formulas (2)-1 and (2)-2, and the binder resin has a molecular structure that prevents any matrix-domain structure from being formed in the electrically conductive layer.

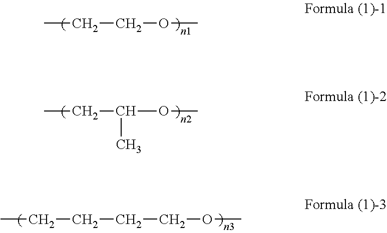

In the formula (1)-1, n1 represents an integer of 1 or more; in the formula (1)-2, n2 represents an integer of or more; and, in the formula (1)-3, n3 represents an integer of 1 or more.

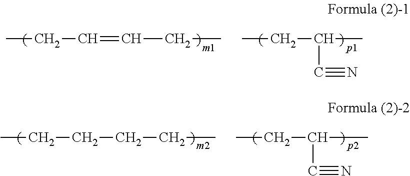

In the formula (2)-1, m1 and p1 each independently represent an integer of 1 or more, and the ratio of m1 to p1, m1:p1, is from 74:26 to 90:10; and, in the formula (2)-2, m2 and p2 each independently represent an integer of 1 or more, and the ratio of m2 to p2, m2:p2, is from 74:26 to 90:10.

According to another aspect of the present invention, there is provided a process cartridge which is so constituted as to be detachably mountable to the main body of an electrophotographic apparatus, and has the above conductive member. According to further aspect of the present invention, there is provided an electrophotographic apparatus which has the above conductive member.

According to the present invention, an electrically conductive member for electrophotography can be obtained which has a small dependence of electrical resistance on environmental variations while keeping any ion conducting agent from bleeding to its surface. According to the present invention, a process cartridge and an electrophotographic apparatus can also be obtained which contribute to stable formation of high-grade electrophotographic images.

Further features of the present invention will become apparent from the following description of exemplary embodiments with reference to the attached drawings.

### BRIEF DESCRIPTION OF THE DRAWINGS

FIG. 1A is a schematic sectional view showing an embodiment of the conductive member for electrophotography according to the present invention.

FIG. 1B is a schematic sectional view showing another embodiment of the conductive member for electrophotography according to the present invention.

FIG. 1C is a schematic sectional view showing still another embodiment of the conductive member for electrophotography according to the present invention.

FIG. 2 is a schematic structural view showing an example of an electrophotographic image forming apparatus having the conductive member for electrophotography according to the present invention.

FIG. 3 is a schematic view of the construction of an instrument for measuring electric current of an elastic layer.

### DESCRIPTION OF THE EMBODIMENTS

In the following, as a specific example of the conductive member for electrophotography according to the present invention, the present invention is described in detail taking note of a roller-shaped conductive member (hereinafter often “conductive roller”).

Conductive Member for Electrophotography

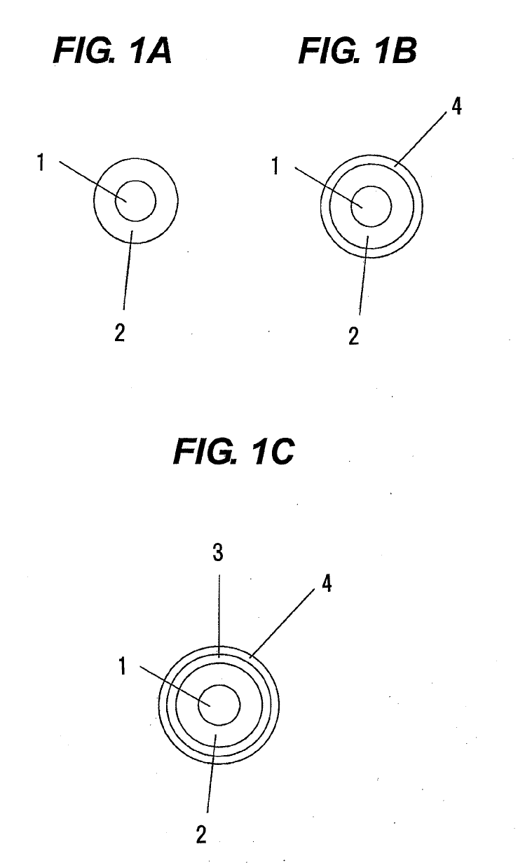

FIGS. 1A, 1B and 1C are schematic views showing embodiments of the conductive member for electrophotography (hereinafter often simply “conductive member”). The conductive member may be, as shown in FIG. 1A, of single-layer construction in which it consists of an electrically conductive mandrel 1 and, provided on its peripheral surface, an elastic layer 2, or, as shown in FIG. 1B, of double-layer construction in which it is provided with a surface layer 4 on the outer side of the elastic layer 2. It may further be, as shown in FIG. 1C, of multiple-layer construction in which it is provided with an intermediate layer 3 and/or an adhesive layer between the elastic layer 2 and the surface layer, in a plurality of layers.

At least any of the elastic layer 2, the surface layer 4 and the intermediate layer 3 that are shown in FIGS. 1A, 1B and 1C is the electrically conductive layer in the present invention. Any layer other than the electrically conductive layer in the present invention may also be made electrically conductive by any other means. It, however, is desirable for such layer other than the electrically conductive layer in the present invention to have a lower electrical resistance value than the electrically conductive layer in the present invention so that the conductivity of the conductive member for electrophotography can be controlled by the electrically conductive layer according to the present invention.

Electrically Conductive Layer

Alkylene Oxide Structure:

In the present invention, as a means by which the electrically conductive layer is kept from increasing in electrical resistance in a low-temperature and low-humidity environment, the electrically conductive layer contains a binder resin having an alkylene oxide structure in the molecular chain. The alkylene oxide structure has a great polarity and is effective in promoting the dissociation of ions like water, and hence the electrically conductive layer can be kept from increasing in electrical resistance even in a low-temperature and low-humidity environment, in which the binder resin may have a small water content. The alkylene oxide structure is any structure selected from the group consisting of structures represented by the following formulas (1)-1 to (1)-3.

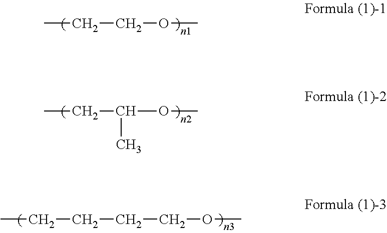

In the formula (1)-1, n1 represents an integer of 1 or more; in the formula (1)-2, n2 represents an integer of or more; and, in the formula (1)-3, n3 represents an integer of 1 or more.

Standing at the point of ionic dissociation, a compound having, among the above alkylene oxide structures, the alkylene oxide structure represented by the formula (1)-1 may particularly be used, where the binder resin can be made to have lower resistance in a low-temperature and low-humidity environment. The structure represented by the formula (1)-1 is relatively highly hydrophilic when compared with the structures represented by the formulas (1)-2 and (1)-3, and hence tends to make the binder resin have a large water content in a high-temperature and high-humidity environment.

Accordingly, where the binder resin is incorporated with the structure represented by the formula (1)-1, in order to make the electrically conductive layer much less vary in electrical resistance in a high-temperature and high-humidity environment, the structure represented by the formula (1)-1 may preferably be in a content kept down to 30% by mass or less, and particularly preferably 20% by mass or less, in the binder resin.

Where on the other hand the structure represented by the formula (1)-2 or (1)-3 is used as the alkylene oxide structure, the binder resin by no means greatly comes to have a large water content in a high-temperature and high-humidity environment even where the binder resin is in a large content. Also, though inferior to the structure represented by the formula (1)-1, the structure represented by the formula (1)-2 or (1)-3 contributes sufficiently to the effect of keeping the electrically conductive layer from increasing in electrical resistance even in a low-temperature and low-humidity environment, and hence the latter is preferred from the viewpoint of the environmental dependence of electrical resistance value.

The structure represented by the formula (1)-2 or (1)-3 may preferably be in a content of from 10% by mass or more to 70% by mass or less in the binder resin. Inasmuch as it is in a content of 10% by mass or more, the electrically conductive layer can be kept from increasing in electrical resistance even in a low-temperature and low-humidity environment. Inasmuch as it is in a content of 70% by mass or less, the electrically conductive layer can be kept from excessively decreasing in electrical resistance in a high-temperature and high-humidity environment.

The type and content of the alkylene oxide structure in the binder resin may be determined by making solid-state ¹³C-NMR measurement on a sample partly cut out from the electrically conductive layer, and analyzing peak positions and intensity ratios. Infrared (IR) spectroscopy may further be used to identify the molecular structure, and the results obtained may be combined with the results of the NMR measurement, thereby more facilitating the quantitative determination of the alkylene oxide structure.

In order to introduce into the binder resin any of the structures represented by the formulas (1)-1 to (1)-3, an alkylene oxide compound having at both the terminals thereof functional groups capable of reacting with other raw material(s) constituting the binder resin may be used as a raw material. As the functional groups, there are no particular limitations thereon as long as they react with other raw-material(s), and they may include the following: A hydroxyl group, an amino group, a carboxyl group, a mercapto group, an alkoxyl group, a vinyl group, a glycidyl group, an epoxy group and an isocyanate group.

The molecular weight of the raw-material alkylene oxide compound is also important because it has influence on the electrical resistance value in a low-temperature and low-humidity environment. The values of n1, n2 and n3 in the structures represented by the formulas (1)-1 to (1)-3, respectively, representing the number of linkage of each unit may be made large, whereby the distance between linking groups can be made large and this can make the binder resin have a small crosslink density. Making the binder resin have a small crosslink density makes the binder resin improved in behavior for its molecular motion, and hence this makes the mobility of dissociated ions large, and is preferable for the binder resin to be kept from coming to have a high resistance in a low-temperature and low-humidity environment.

If on the other hand the values of n1, n2 and n3 are made too large, the alkylene oxide structure tends to cause its crystallization, and this is especially remarkable in the case of the structure represented by the formula (1)-1. Also, the number of reactive functional groups contributing to cross-linking reaction becomes so small as to make the cross-linking reaction not easily take place, bringing about a possibility of an increase in any unreacted product that may be contained in the binder resin.

For the reasons as stated above, the values of n1, n2 and n3 in the structures represented by the formulas (1)-1 to (1)-3, respectively, may preferably be from 4 to 22.

Nitrile Group:

Where a nitrile group having a high dielectric constant is present at a short distance from the alkylene oxide structure, the effect of promoting the dissociation of ions is more amplified than a case in which each of them is used alone, and the binder resin can be made to have much lower resistance in a low-temperature and low-humidity environment. Hence, the binder resin in the present invention is characterized by having in its molecular chain such a nitrile group. The nitrile group is any structure selected from the group consisting of structures represented by the following formulas (2)-1 and (2)-2. The structure represented by formula (2)-2, which is a structure wherein hydrogen has been added to the double bond of the butadiene unit in the structure represented by the formula (2)-1, is more improved in ozone resistance or wear resistance than the structure represented by the formula (2)-1, and hence preferable when it is used in a charging member or a developing member.

In order to bring the nitrile group and the alkylene oxide structure into vicinity to each other at the level of molecules, it is preferable that the number of linkage of each unit of the structures represented by the formulas (1)-1 to (1)-3 and of the structures represented by the formulas (2)-1 and (2)-2 is small and that the structure represented by the formula (1)-1 and the structure represented by the formula (1)-2 are alternately linked. Also, the number of linkage of the structures represented by the formulas (1)-1 to (1)-3 and of the structures represented by the formulas (2)-1 and (2)-2 may be made small, and this can prevent any matrix-domain structure from being formed in the electrically conductive layer on account of the binder resin.

Herein, what is meant by the “matrix-domain structure” in the present invention is a structure in which the structure represented by the formula (1) and structure represented by the formula (2) that constitute the binder resin each stand unevenly distributed, where a phase containing any one of them constitutes a matrix and a phase containing the other structure constitutes a domain. Then, in the present invention, what is meant by “preventing any matrix-domain structure from being formed” is that any matrix-domain structure is not formed in the electrically conductive layer on account of the molecular structure the binder resin itself has.

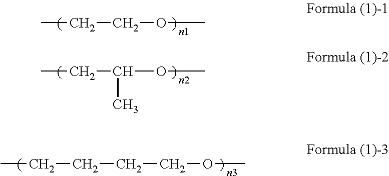

In the formula (1)-1, n1 represents an integer of 1 or more; in the formula (1)-2, n2 represents an integer of or more; and, in the formula (1)-3, n3 represents an integer of 1 or more.

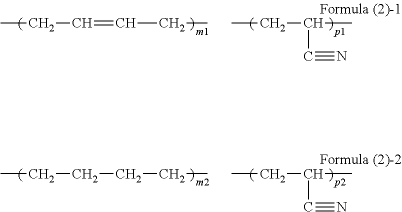

In the formula (2)-1, m1 and p1 each independently represent an integer of 1 or more, and the ratio of m1 to p1, m1:p1, is from 74:26 to 90:10; and, in the formula (2)-2, m2 and p2 each independently represent an integer of 1 or more, and the ratio of m2 to p2, m2:p2, is from 74:26 to 90:10.

The ratio of m1 to p1 [m1:p1] and the ratio of m2 to p2 [m2:p2] in the structures represented by the formulas (2)-1 and (2)-2, respectively, which m1, p1, m2 and p2 each represent the number of linkage of each unit, are both from [74:26] to [90:10]. Setting the ratio of p1 and p2 to be 26 or less can keep the binder resin from absorbing water in excess in a high-temperature and high-humidity environment on account of the nitrile group, having a high polarity, and can keep the binder resin from coming to electrically discharge in excess because of its resistance made low. Setting also the ratio of p1 and p2 to be 10 or more can secure the number of nitrile groups that is effective in dissociating ions, and hence can bring out the effect of making the binder resin have a low resistance in a low-temperature and low-humidity environment.

As molecular weight of the structures represented by the formulas (2)-1 and (2)-2 each, it may preferably be from 1,400 or more to 3,800 or less, and much preferably from 1,800 or more to 3,500 or less. Making them have a molecular weight of 1,400 or more makes the binder resin improved in behavior for its molecular motion. This makes the mobility of dissociated ions large, and hence is preferable for the binder resin to be kept from coming to have a high resistance in a low-temperature and low-humidity environment. Inasmuch as they have a molecular weight of 3,800 or less, the alkylene oxide structure represented by the formula (1) and the nitrile group represented by the formula (2) come into vicinity to each other at the level of molecules as described previously, and hence it can more surely be achieved to reduce the environmental dependence of electrical resistance value.

The number of linkage of each unit of the structures represented by the formulas (1)-1 to (1)-3 and of the structures represented by the formulas (2)-1 and (2)-2 in the binder resin may be found in the following way. For example, it may be estimated by ionizing a sample by matrix-assisted laser desorption/ionization (MALDI) or surface-assisted laser desorption/ionization (SALDI), and thereafter doing mass spectrometry making use of a time-of-flight mass spectrometric analyzer (TOF-MS).

In order to introduce into the binder resin any of the structures represented by the formulas (2)-1 and (2)-2, a modified liquid NBR (nitrile butadiene rubber) having at both the terminals thereof functional groups capable of reacting with other raw-material(s) constituting the binder resin may preferably be used as a raw material. As the functional groups, there are no particular limitations thereon as long as they react with other raw-material(s), and they may include the following: A hydroxyl group, an amino group, a carboxyl group, a mercapto group, an alkoxyl group, a vinyl group, a glycidyl group, an epoxy group and an isocyanate group.

As the binder resin, an epoxy resin is preferred which is obtained by allowing an epoxy-modified ethylene oxide having the structure represented by the formula (1)-1 to react with an amino-modified liquid-state NBR having the structure represented by the formula (2)-1. The reaction of the amino group with the epoxy group proceeds only by mixing and heating the materials, and hence the binder resin in the present invention can simply and easily be obtained. For both the epoxy-modified ethylene oxide and the amino-modified liquid-state NBR, raw materials different in the number of linkage of each unit, their molecular weight and so forth are also on the mark in a large number, and are readily available.

The binder resin in the present invention has the molecular structure that prevents any matrix-domain structure from being formed in the electrically conductive layer on account of the binder resin. In order to make any matrix-domain structure not form in the electrically conductive layer on account of the binder resin, it is effective that, as described previously, the number of linkage of each unit of the structures represented by the formulas (1) and (2) is small or the structure represented by the formula (1) and the structure represented by the formula (2) are alternately linked.

Incidentally, although it is necessary in the present invention that any matrix-domain structure stands not formed in the electrically conductive layer on account of the binder resin itself, there is by no means excluded such an electrically conductive layer that a domain stands formed against a matrix composed of that binder resin on account of any other resin, filler, particles and so forth added to the electrically conductive layer, as long as the effect aimed in the present invention is not damaged.

The presence of the matrix-domain structure in the electrically conductive layer on account of the binder resin may be ascertained by observation with a transmission electron microscope (TEM) and a scanning electron microscope (SEM-EDX). Stated specifically, a sample cut out from the electrically conductive layer is embedded in a cold-setting epoxy resin, which is then cured and thereafter cut with a microtome in the shape of a leaf of 100 to 300 nm in thickness to prepare a sample for observation. Next, the sample for observation is photographed at 100,000 magnifications with use of the TEM, and marking is put on the photograph obtained, at its portion where a continuous phase is formed. Subsequently, elementary analysis of the sample for observation is made by using the SEM-EDX, where it may be ascertained that the marking portion stands the binder resin in the present invention.

Linking Group:

It is preferable that any structure selected from the group consisting of structures represented by the formulas (1)-1 to (1)-3 and any structure selected from the group consisting of structures represented by the formulas (2)-1 and (2)-2 stand linked with at least one linking group selected from the group consisting of structures represented by the following formulas (3)-1 to (3)-8. Where they stand linked with any linking group selected from the group consisting of structures represented by the formulas (3)-1 to (3)-8, the polar group in the linking group promotes the dissociation of ions, and hence the binder resin can be more kept from coming to have a high resistance in a low-temperature and low-humidity environment.

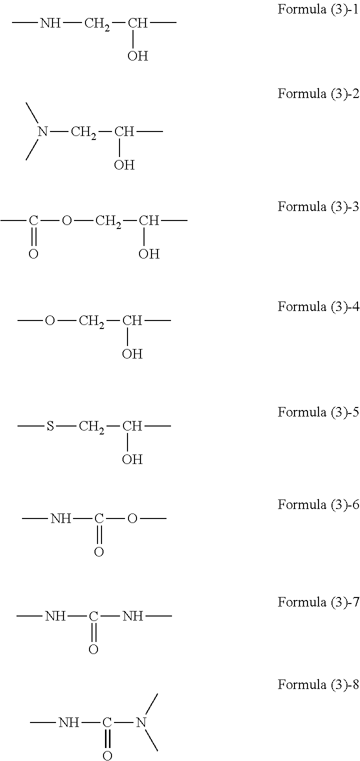

Ion Exchange Group:

The binder resin in the present invention is characterized by having in the molecule a sulfo group or a quaternary ammonium salt group as an ion exchange group, having a high ionic dissociation performance. This ion exchange group stands linked with the binder resin by covalent linkage. Since the ion exchange group stand chemically linked with the binder resin, the ion exchange group is kept from moving in the electrically conductive layer, and hence, compared with an electrically conductive layer making use of an ion conducting agent not standing linked with the binder resin, any ionic component may less bleed and the electrical resistance can not easily vary even with application of direct current for a long time.

In order to introduce the ion exchange group into the binder resin, the above ion conducting agent used in ion exchange reaction is required to have a functional group capable of reacting with the binder resin. As the functional group there are no particular limitations thereon as long as it reacts with the binder resin used as a raw material, and it may include the following: Halogen atoms such as fluorine, chlorine, bromine and iodine, acid groups such as a carboxyl group and an acid anhydride, as well as a hydroxyl group, an amino group, a mercapto group, an alkoxyl group, a vinyl group, a glycidyl group, an epoxy group, a nitrile group and a carbamoyl group.

The ion exchange group may be introduced into the binder resin at its backbone chain or may be introduced thereinto at its molecular terminal. Where the ion exchange group is introduced into the binder resin at its backbone chain, it may preferably stand linked with a linking group having a structure represented by the following formula (4).

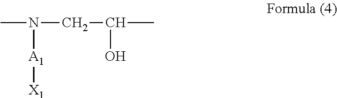

In the formula (4), A₁ represents a divalent organic group, and X₁ represents an ion exchange group.

Where the ion exchange group is introduced into the binder resin at its molecular terminal, it may preferably stand linked with at least one linking group selected from the group consisting of structures represented by the following formulas (5)-1 to (5)-7.

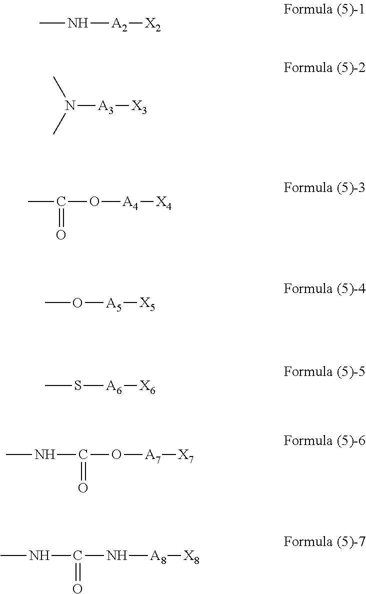

In the formulas (5)-1 to (5)-7, A₂ to A₈ each represent a divalent organic group, and X₂ to X₈ each represent an ion exchange group.

Where the ion exchange group is introduced through any linking group selected from the group consisting of the structure represented by the formulas (4) and the structures represented by the formulas (5)-1 to (5)-7, the polar group in the linking group promotes the dissociation of ions, and hence the binder resin can be more kept from coming to have a high resistance in a low-temperature and low-humidity environment.

Whether or not the ion exchange group stands introduced into the binder resin may be verified in the following way. The binder resin of a sample cut out from the electrically conductive layer is extracted with toluene by using a Soxhlet extractor, and the binder resin having been extracted may be measured by solid-state NMR or infrared (IR) spectroscopy to identify its molecular structure.

The amount of the ion conducting agent to be added may appropriately be prescribed, where the ion conducting agent may preferably be mixed in a proportion of from 0.5 parts by mass or more to 20 parts by mass or less, based on 100 parts by mass of the binder resin as a raw material. Inasmuch as it is mixed in an amount of 0.5 parts by mass or more, the effect of providing conductivity in virtue of the ion conducting agent can be obtained. Also, inasmuch as it is in an amount of 20 parts by mass or less, the environmental dependence of electrical resistance value can be reduced.

Counter Ion:

The electrically conductive layer in the present invention also contains an ion with a polarity opposite to that of the ion exchange group (hereinafter “counter ion”). Where the ion exchange group is a sulfo group, the counter ion may include the following: Alkali metal ions such as a proton, a lithium ion, a sodium ion and a potassium ion; and imidazolium compound ions, pyrrolidinium compound ions and quaternary ammonium compound ions. Where the ion exchange group is a quaternary ammonium group, the counter ion may include the following: Halide ions such as a fluoride ion, a chloride ion, a bromide ion and an iodide ion; and perchlorate ions, sulfonic acid compound ions, phosphoric acid compound ions, boric acid compound ions and sulfonyl imide ions.

As a combination of the ion exchange group and the counter ion, a combination of a quaternary ammonium salt group and a sulfonyl imide ion is preferred. This combination is preferable in that it makes the counter ion readily dissociate and can better keep the binder resin from coming to have a high resistance in a low-temperature and low-humidity environment.

The sulfonyl imide ion may include, but is not particularly limited to, the following: A bis(trifluoromethanesulfonyl)imide ion, a bis(pentafluoroethanesulfonyl)imide ion, a bis(nonafluorobutanesulfonyl)imide ion and a cyclo-hexafluoropropane-1,3-bis(sulfonyl)imide ion.

The counter ion may be ascertained by an extraction experiment that utilizes ion exchange reaction. The binder resin of a sample cut out from the electrically conductive layer is stirred in a dilute aqueous solution of hydrochloric acid or sodium hydroxide to extract ions present in the binder resin into the aqueous solution. The aqueous solution after extraction is dried to collect the extract, and thereafter mass spectrometry may be made with use of a time-of-flight mass spectrometric analyzer (TOF-MS) to identify the ions. Elementary analysis may further be made by inductively coupled plasma (ICP) emission spectrometry of the extract, and this more facilitates the identification of the ions.

The ion exchange group and counter ion used in the present invention may be produced by utilizing ion exchange reaction of the ion conducting agent having the sulfo group or quaternary ammonium salt group with an ion salt having the desired chemical structure. For example, where lithium bis(trifluoromethane-sulfonyl)imide is used as the ion salt and glycidyl trimethylammonium chloride is used as the ion exchange group, each of them is first dissolved in purified water. Two aqueous solutions of these may be mixed and stirred, whereupon a chloride ion, having a high ion exchangeability, is substituted with a bis(trifluoromethanesulfonyl)imide ion by the ion exchange reaction. The glycidyl trimethylammonium-bis(trifluoromethanesulfonyl)imide thus formed is an ionic liquid that exhibits hydrophobic nature, and hence the by-product water-soluble lithium chloride is readily removable. Even where the ion conducting agent obtained by this method is hydrophilic, the by-product is readily removable by selecting solvents such as chloroform, dichloromethane, dichloroethane and methyl isobutyl ketone.

Where the electrically conductive layer in the present invention is used as an intermediate layer or a surface layer, the electrically conductive layer may preferably have a layer thickness of from 2 μm or more to 100 μm or less. Inasmuch as it has a layer thickness of 2 μm or more, the electrical resistance value of the conductive member can be regulated by the electrically conductive layer even when the elastic layer has a low electrical resistance value. Also, inasmuch as it has a layer thickness of 100 μm or less, the conductive member may no longer increase in electrical resistance value in excess even in a low-temperature and low-humidity environment.

Conductive Mandrel

The electrically conductive mandrel has conductivity in order to supply electricity to the surface of the conductive member such as a charging roller or a developing roller through the mandrel.

Elastic Layer

Where the electrically conductive layer in the present invention is used as the intermediate layer or the surface layer as shown in FIG. 1B, the elastic layer may be made up of materials described in the following.

As a rubber component that forms the elastic layer, there are no particular limitations thereon as long as it can secure a sufficient nip between the charging roller or developing roller and a photosensitive drum, and it may include the following: Epichlorohydrin rubber, NBR (nitrile butadiene rubber), chloroprene rubber, urethane rubber and silicone rubber, or SBS (styrene-butadiene-styrene block copolymer) and SEBS (styrene-ethylenebutylene-styrene block copolymer). Any of these may be used alone or in combination of two or more types.

The elastic layer may preferably have an electrical resistance value of from 1×10²Ω or more to 1×10⁸Ω or less as measured in an environment of temperature: 23° C. and relative humidity: 50%. To the elastic layer, a conducting agent may be added for the purpose of providing it with conductivity. As the conducting agent, an electron conducting agent or an ion conducting agent may be used.

The electron conducting agent may include, but is not particularly limited to, the following: Carbon black, graphite, metal oxides such as titanium oxide, tin oxide and zinc oxide, powders of metals such as aluminum and nickel, and conductive fibers. Of these, carbon black is preferable as being readily available. As types of the carbon black, it may include, but is not particularly limited to, the following: Gas furnace black, oil furnace black, thermal black, lamp black, acetylene black and KETJEN black.

The ion conducting agent may include, but is not particularly limited to, the following: Inorganic ionic substances such as lithium perchlorate, sodium perchlorate and calcium perchlorate; cationic surface-active agents such as lauryl trimethylammonium chloride, stearyl trimethylammonium chloride, octadecyl trimethylammonium chloride, dodecyl trimethylammonium chloride, hexadecyl trimethylammonium chloride, trioctyl propylammonium bromide, and modified aliphatic dimethyl ethylammonium ethosulfate; amphoteric ionic surface-active agents such as lauryl betaine, stearyl betaine, and dimethylalkyl lauryl betaine; quaternary ammonium salts such as tetraethylammonium perchlorate, tetrabutylammonium perchlorate and trimethyloctadecylammonium perchlorate; and organic-acid lithium salts such as lithium trifluoromethane sulfonate. Any of these may be used alone or in combination of two or more types.

To the elastic layer, additives such as insulating particles, a softening oil for regulating hardness, and a plasticizer may be added. As the plasticizer, it is much preferable to use a polymeric type one, which may preferably have a molecular weight of 2,000 or more, and much preferably 2,000 or more. Further, the elastic layer may appropriately be incorporated with materials capable of providing it with various functions, which materials may include, as examples thereof, an antioxidant and a filler.

The elastic layer may be formed by bonding to the mandrel, or covering it with, a sheet or tube obtained by beforehand forming elastic layer materials into it in a stated layer thickness. It may also be produced by extruding the mandrel and the elastic layer materials integrally, using an extruder having a cross head.

Intermediate Layer, Surface Layer

Where the electrically conductive layer in the present invention is used as the elastic layer, the intermediate layer or the surface layer may be made up of resin, natural rubber or synthetic rubber. As the resin, any of resins such as thermosetting resins and thermoplastic resins may be used. In particular, preferred as the resin are fluorine resins, polyamide resins, acrylic resins, polyurethane resins, silicone resins and butyral resins. Any of these may be used alone or in combination in the form of a mixture of two or more types, or may be a copolymer.

The intermediate layer or the surface layer may be mixed with a conducting agent in order to regulate the electrical resistance value of the conductive member. The volume resistivity of the intermediate layer or surface layer may be regulated with an ion conducting agent or an electron conducting agent.

The ion conducting agent may include the same ones as in the case of the above elastic layer.

The electron conducting agent may include the following: Fine particles or fibers of metals such as aluminum, palladium, iron, copper and silver; conductive metal oxides such as titanium oxide, tin oxide and zinc oxide; the above metallic fine particles or fibers and metal oxides the surfaces of which have been surface-treated by electrolytic processing, spray coating or mixing-and-shaking; and carbon powders such as furnace black, thermal black, acetylene black, KETJEN BLACK, PAN (polyacrylonitrile) type carbon, and pitch type carbon.

The intermediate layer or the surface layer may be incorporated with other particle as long as the effect aimed in the present invention is not damaged. Such other particle may include insulating particles. The insulating particles may include the following: Particles of resins such as polyamide resins, silicone resins, fluorine resins, acrylic or methacrylic resins, styrene resins, phenol resins, polyester resins, melamine resins, urethane resins, olefin resins, epoxy resins, and copolymers, modified products or derivatives of these; particles of rubbers such as an ethylene-propylene-diene copolymer (EPDM), styrene-butadiene copolymer rubber (SBR), silicone rubbers, urethane rubbers, isoprene rubber (IR), butyl rubber, acrylonitrile-butadiene copolymer rubber (NBR), chloroprene rubber (CR) and epichlorohydrin rubbers; and particles of thermoplastic elastomers such as polyolefin type thermoplastic elastomers, urethane type thermoplastic elastomers, polystyrene type thermoplastic elastomers, fluorine rubber type thermoplastic elastomers, polyester type thermoplastic elastomers, polyamide type thermoplastic elastomers, polybutadiene type thermoplastic elastomers, ethylene vinyl acetate type thermoplastic elastomers, polyvinyl chloride type thermoplastic elastomers, and chlorinated polyethylene type thermoplastic elastomers. In particular, particles of acrylic or methacrylic resins, styrene resins, urethane resins, fluorine resins or silicone resins are preferred.

Any of these materials making up the intermediate layer or surface layer may be dispersed in a liquid by using any conventionally known dispersion machine that utilizes beads, as exemplified by a sand mill, a paint shaker, Daino mill or Pearl mill. There are no particular limitations on how to apply the dispersion obtained, and dipping is preferable because it is simply operable.

Electrophotographic Apparatus & Process Cartridge The conductive member according to the present invention may preferably be used as, e.g., a charging member provided in contact with a charging object member such as a photosensitive member so as to charge the charging object member electrostatically. The conductive member according to the present invention may also preferably be used as the charging member in a process cartridge which has a charging object member and a charging member provided in contact with the charging object member to charge the charging object member electrostatically with application of a voltage, and is so set up as to be detachably mountable to the main body of an image forming apparatus.

Besides the charging member such as a charging roller, the conductive member according to the present invention may also be used as a developing member, a transfer member, a charge elimination (destaticizing) member, and a transport member such as a paper feed roller.

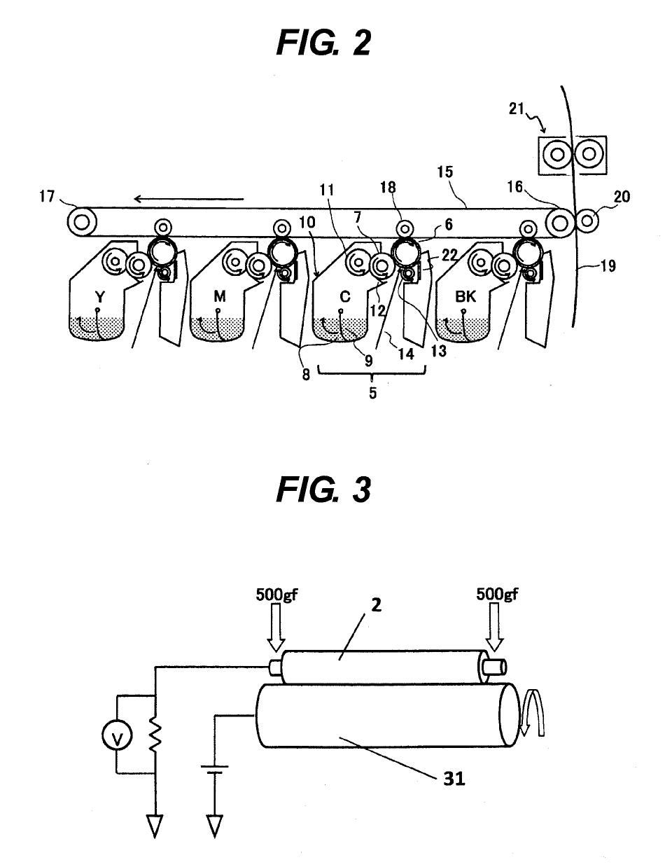

An example of an electrophotographic image forming apparatus having the conductive member of the present invention is described with reference to FIG. 2. The electrophotographic image forming apparatus shown in FIG. 2 is provided, in a tandem fashion, with electrophotographic process cartridges 5 each in one set for those which form yellow, cyan, magenta and black images.

Their developing assembles each have a developing roller 7 disposed facing a photosensitive drum 6, a toner 8 and a toner container 10 which holds therein an agitating blade 9 with which the toner is drawn up. They are each further provided with a toner feed roller 11 for feeding the toner to the developing roller and also scraping any toner off, remaining on the developing roller without participating in development, and a developing blade 12 for controlling toner-carrying level on the developing roller and also charging the toner triboelectrically.

Each charging roller 13 is kept in contact with the photosensitive drum at a stated pressing force, and rotated followingly with the rotation of the photosensitive drum. Then, the photosensitive drum is uniformly charged to stated polarity and potential by applying a direct voltage to the charging roller from a power source. The surface of the photosensitive drum is exposed to a beam 14 corresponding to image information, whereupon an electrostatic latent image is formed on the surface. Next, the toner, having been coated on the developing roller, is fed from the developing roller onto the electrostatic latent image, thus a toner image is formed on the photosensitive drum.

An intermediate transfer belt 15 is put over a drive roller 16 and a tension roller 17, and, inside the intermediate transfer belt, transfer rollers 18 are each provided at the position facing the photosensitive drum. Then, a transfer material 19 is transported to the transfer position, where a bias voltage with polarity opposite to that of the toner image is applied to a transfer roller 20. Thus, toner images are transferred to the transfer material.

The transfer material to which the toner images have been transferred is sent to a fixing assembly 21, where the toner images are fixed to the transfer material, thus image formation is completed. Meanwhile, photosensitive drums from which the toner images have been transferred are further rotated, and the surfaces of the photosensitive drums are each cleaned with a cleaning blade 22.

The conductive member of the present invention may be used as the charging roller or developing roller in the above electrophotographic image forming apparatus. Also, besides the above electrophotographic image forming apparatus of a DC charging system, in which only the direct voltage is applied, the conductive member of the present invention may be used also in an electrophotographic image forming apparatus of an AC charging system in which voltages produced by superimposing an alternating voltage on a direct voltage are applied.

### EXAMPLES

The present invention is described below in greater detail by giving working examples. Incidentally, Example 53 is concerned with the conductive member shown in FIG. 1C, which is so set up that the elastic layer, the intermediate layer (the electrically conductive layer in the present invention) and the surface layer are provided in this order on the peripheral surface of the mandrel. Examples 50 and 70 are concerned with the conductive member shown in FIG. 1A, which is so set up that the electrically conductive layer in the present invention is provided on the peripheral surface of the mandrel. Examples and Comparative Examples other than these are concerned with the conductive member shown in FIG. 1B, which is so set up that the elastic layer and the surface layer (the electrically conductive layer in the present invention) are provided in this order on the peripheral surface of the mandrel.

Production of elastic rollers A to C used in Examples, and also production and preparation of ion conducting agents a to h, are described first.

Production of Elastic Roller A:

Materials shown in Table 1 below were mixed by means of a 6-liter pressure kneader (product name: TD6-15MDX; manufactured by Toshin Co., Ltd.) for 16 minutes in a packing of 70 vol. % and at a number of blade revolutions of 35 rpm to obtain an “unvulcanized rubber composition 1”.

TABLE 1

| | Part(s) |
|---|---|
| Materials | by mass |
| NBR | 100 |
| (trade name: NIPOL DN219; available from | |
| Nippon Zeon Co., Ltd.) | |
| Carbon black | 48 |
| (trade name: #7360SB; available from | |
| Tokai Carbon Co., Ltd.) | |
| Calcium carbonate | 20 |
| (trade name: NANOX #30; available from | |
| Maruo Calcium Co., Ltd.) | |
| Zinc oxide | 5 |
| (trade name: Zinc Oxide Type II, available | |
| from Seido Chemical Industry Co. Ltd.) | |
| Zinc stearate | 1 |

Next, to 174 parts by mass of this unvulcanized rubber composition, 4.5 parts by mass of tetrabenzylthiuram disulfide (trade name: PERKACIT TBzTD; available from Flexis AG) as a vulcanization accelerator and 1.2 parts by mass of sulfur as a vulcanizing agent were added. Then, these were mixed by means of an open roll of 12 inches in roll diameter at a number of front-roll revolutions of 8 rpm and a number of back-roll revolutions of 10 rpm and at a roll gap of 2 mm, carrying out right and left 20 cuts in total. Thereafter, the roll gap was changed to 0.5 mm to carry out tailing 10 times to obtain a “kneaded product 1 for elastic layer”.

Next, a mandrel made of steel having been surface-plated with nickel and in a columnar shape of 6 mm in diameter and 252 mm in length was readied, and was coated with a heat-hardening adhesive (trade name: METALOC U-20, available from Toyokagaku Kenkyusho Co., Ltd.) over the area of 231 mm in width of the mandrel in its axial direction. Then, the wet coating formed was heated at 80° C. for 30 minutes, and thereafter further heated at 120° C. for 1 hour to harden the heat-hardening adhesive by heating.

The kneaded product 1 for elastic layer was extruded together with the above-processed mandrel by means of an extruder having a cross head, to obtain an “unvulcanized rubber roller” of 8.75 to 8.90 mm in diameter which was coated with the kneaded product on the outer periphery of the mandrel. The extruder having a cross head had a cylinder diameter of 70 mm and an L/D of 20, where head temperature was set at 90° C., cylinder temperature at 90° C. and screw temperature at 90° C.

Next, this rubber roller was vulcanized by using a continuous heating oven having two zones set at different temperatures. A first zone was set at a temperature of 80° C., where the roller was passed therethrough in 30 minutes, and a second zone was set at a temperature of 160° C., where the roller was subsequently passed therethrough in 30 minutes, to obtain a roller with a “vulcanized elastic layer”.

This roller was cut at its both end portions of the elastic layer to make the elastic layer have a length of 232 mm in the axial direction. Thereafter, the surface of the elastic layer was sanded with a rotary grinding wheel. Thus, an “elastic roller A” was obtained which had a crown shape of 8.26 mm in diameter at end portions and 8.50 mm in diameter at the middle portion.

Evaluation 1: Measurement of Electric Current of Elastic Layer.

The construction of an instrument for measuring electric current of the elastic layer is schematically shown in FIG. 3. An elastic layer 2 provided on a mandrel is kept in pressure contact with a cylindrical aluminum drum 31 of 30 mm in diameter at both end portions of the mandrel by means of a press-down means (not shown), and is follow-up rotated as the aluminum drum 31 is rotatingly driven. It is pressed down at a pressure of 500 gf on each end portion (1,000 gf in total on both end portions). While the aluminum drum 31 is rotated at 30 rpm, a direct voltage (200 V) is applied to the mandrel by using an external power source, where the value of voltage across a reference resistance (1,000Ω) connected in series with the aluminum drum is measured. The current value of the elastic layer 31 may be calculated from the resistance value of the reference resistance and the value of voltage across the reference resistance. As measuring environment, it was measured in two environments, an environment of temperature: 15° C. and relative humidity: 10%) (hereinafter often “L/L environment”) and an environment of temperature: 30° C. and relative humidity: 80%) (hereinafter often “H/H environment”). The results of the measurement of electric current value are shown in Table 7-1.

Production of Elastic Roller B:

Materials shown in Table 2 below were mixed for 10 minutes by means of a pressure kneader temperature-controlled at 100° C., to obtain an unvulcanized rubber composition 2.

TABLE 2

| | Part(s) |
|---|---|
| Materials | by mass |
| Epichlorohydrin rubber | 100 |
| (epichlorohydrin/ethylene oxide/ | |
| allylglycidyl ether = 40 mol %/56 mol %/4 mol %) | |
| Carbon black | 8 |
| (trade name: SEAST SO; available from | |
| Tokai Carbon Co., Ltd.) | |
| Calcium carbonate | 35 |
| (trade name: SILVER W; available from | |
| Maruo Calcium Co., Ltd.) | |
| Zinc oxide | 5 |
| (trade name: Zinc Oxide Type II, available | |
| from Seido Chemical Industry Co. Ltd.) | |
| Zinc stearate | 2 |
| Tetrabutylammonium perchlorate | 5 |
| Adipate | 10 |
| (trade name: POLYCIZER W305ELS, available | |
| from Dainippon Ink & Chemicals, Inc.) | |

Next, to 165 parts by mass of this unvulcanized rubber composition, 2 parts by mass of dipentamethylenethiuram tetrasulfide (trade name: NOCCELER TRA; available from Ouchi-Shinko Chemical Industrial Co. Ltd.) as a vulcanization accelerator and 0.5 part by mass of sulfur as a vulcanizing agent were added. Further, in the same way as the case of the elastic roller A, a like kneaded product was obtained and a like mandrel was surface-treated. Also, an unvulcanized rubber roller was obtained in the same way as the case of the elastic roller A except that the head temperature, the cylinder temperature and the screw temperature were each set at 70° C.

Next, this rubber roller was vulcanized at a temperature of 160° C. for 30 minutes to obtain a roller with an elastic layer. The roller obtained was cut at its both end portions of the elastic layer to make the elastic layer have a length of 232 mm in its axial direction. Thereafter, the surface of the elastic layer was sanded with a rotary grinding wheel. Thus, an “elastic roller B” was obtained which had a crown shape of 8.26 mm in diameter at end portions and 8.50 mm in diameter at the middle portion. The results of the measurement of electric current value are shown in Table 7-1.

Production of Elastic Roller C:

Materials shown in Table 3 below were kneaded for 3 hours by means of a 2-liter planetary mixer (product name: PLM-2; manufactured by Inoue MFG., Inc.) to obtain an unvulcanized rubber composition 3.

TABLE 3

| | Part(s) |
|---|---|
| Materials | by mass |
| Both-terminal vinyl polydimethylsiloxane | 100 |
| (trade name: DMS-V31; available from | |
| AZmax Co., Ltd.) | |
| Polyhydrogenmethylsiloxane | 4 |
| (trade name: HMS-301; available from | |
| AZmax Co., Ltd.) | |
| Carbon black | 10 |
| (trade name: DENKA BLACK, granular product; | |
| available from | |
| Denki Kagaku Kogyo Kabushiki Kaisha) | |

Next, to 114 parts by mass of this unvulcanized rubber composition, 3 parts by mass of a platinum divinyltetramethyldisiloxane complex (trade name: SIP6830; available from AZmax Co., Ltd.) as a catalyst and 3 parts by mass of 2-methyl-3-butyn-2-ol as a curing retarder were added. Then, these were again kneaded for 10 minutes by means of the 2-liter planetary mixer to obtain a kneaded product for elastic layer.

Next, a mandrel made of steel having been surface-plated with nickel and in a columnar shape of 6 mm in diameter and 275 mm in length was coated with a heat-hardening adhesive (trade name: XP81-405, available from Momentive Performance Materials Inc.) over the area of 236 mm in width of the mandrel in its axial direction. Then, the wet coating formed was heated at a temperature of 150° C. for 30 minutes to harden the heat-hardening adhesive by heating.

The above-processed mandrel was placed at the center of a cylindrical mold, and these mandrel and cylindrical mold were pre-heated at a temperature of 110° C. for 5 minutes. The kneaded product was casted into the cylindrical mold through its casting hole, and then cured by heating at a temperature of 110° C. for 5 minutes. The cylindrical mold was cooled and thereafter the mandrel on which an elastic layer was formed was taken out of the cylindrical mold, and then heated with hot air with a temperature of 200° C. for 2 hours, for the purpose of removing any reaction residues and unreacted low-molecular components remaining in the elastic layer. This was again cooled and thereafter the elastic layer was cut off at its both end portions to obtain an “elastic roller C” having an elastic layer of 3 mm in thickness and 236 mm in length in the axial direction. The results of the measurement of electric current value are shown in Table 7-1.

Production of Ion Conducting Agent a:

8.56 g (56.5 mmol) of glycidyl trimethylammonium chloride and 16.22 g (56.5 mmol) of lithium bis(trifluoromethanesulfonyl)imide were each dissolved in 50 ml of purified water. These two aqueous solutions obtained were mixed and then stirred for 2 hours, and thereafter the mixture obtained was left to stand overnight, whereupon it separated into two layers, a water layer in which lithium chloride dissolved and an oil layer composed of glycidyl trimethylammonium bis(trifluoromethanesulfonyl imide). The oil layer, having been collected by using a separatory funnel, was washed twice with purified water to remove lithium chloride having remained in a small quantity in the oil layer. Thus, an ion conducting agent a was obtained which had a glycidyl group as a reactive functional group. Incidentally, this ion conducting agent has a quaternary ammonium salt group as the ion exchange group and a bis(trifluoromethanesulfonyl imide) ion as the counter ion.

Readiness of Ion Conducting Agent b:

Glycidyl trimethylammonium chloride was used as an ion conducting agent b.

Production of Ion Conducting Agent c:

8.56 g (56.5 mmol) of glycidyl trimethylammonium chloride and 7.03 g (56.5 mmol) of sodium perchlorate were each dissolved in 50 ml of purified water. These two aqueous solutions obtained were mixed and then stirred for 2 hours, and thereafter the mixture obtained was left to stand overnight, whereupon it separated into two layers, a water layer in which sodium chloride dissolved and an oil layer composed of glycidyl trimethylammonium perchlorate. The oil layer, having been collected by using a separatory funnel, was washed twice with purified water to remove sodium chloride having remained in a small quantity in the oil layer. Thus, an ion conducting agent c was obtained which had a glycidyl group. Incidentally, this ion conducting agent has a quaternary ammonium salt group as the ion exchange group and a perchlorate ion as the counter ion.

Production of Ion Conducting Agent d:

8.56 g (56.5 mmol) of glycidyl trimethylammonium chloride and 33.17 g (56.5 mmol) of lithium bis(nonafluorobutanesulfonyl)imide were each dissolved in 50 ml of purified water. These two aqueous solutions obtained were mixed and then stirred for 2 hours, and thereafter the mixture obtained was left to stand overnight, whereupon it separated into two layers, a water layer in which lithium chloride dissolved and an oil layer composed of glycidyl trimethylammonium bis(nonafluorobutanesulfonyl imide). The oil layer, having been collected by using a separatory funnel, was washed twice with purified water to remove lithium chloride having remained in a small quantity in the oil layer. Thus, an ion conducting agent d was obtained which had a glycidyl group. Incidentally, this ion conducting agent has a quaternary ammonium salt group as the ion exchange group and a bis(nonafluorobutanesulfonyl imide) ion as the counter ion.

Production of Ion Conducting Agent e:

7.07 g (56.5 mmol) of taurine and 2.26 g (56.5 mmol) of sodium hydroxide were each dissolved in 50 ml of purified water. These two aqueous solutions obtained were mixed and then stirred for 2 hours. After the stirring, the water was evaporated off under reduced pressure to obtain an ion conducting agent e having an amino group as a reactive functional group. Incidentally, this ion conducting agent has a sulfo group as the ion exchange group and a sodium ion as the counter ion.

Production of Ion Conducting Agent f:

2.45 g (14 mmol) of 1-butyl-3-methylimidazolium chloride was dissolved in 50 ml of absolute ethanol. To the solution obtained, 2.05 g (14 mmol) of sodium taurine were added, and these were stirred overnight. After the stirring, the solution was filtered and, from the filtrate obtained, the solvent was evaporated off under reduced pressure to obtain an ion conducting agent f having an amino group. Incidentally, this ion conducting agent has a sulfo group as the ion exchange group and a 1-butyl-3-methylimidazolium ion as the counter ion.

Production of Ion Conducting Agent g:

7.90 g (56.5 mmol) of choline chloride and 16.22 g (56.5 mmol) of lithium bis(trifluoromethanesulfonyl)imide were each dissolved in 50 ml of methanol. These two solutions obtained were mixed and then stirred for 2 hours, and thereafter the methanol was evaporated off under reduced pressure. The residue obtained was extracted with 50 ml of methyl ethyl ketone, followed by filtration. From the filtrate obtained, the solvent was evaporated off under reduced pressure to obtain an ion conducting agent g having a hydroxyl group. Incidentally, this ion conducting agent has a quaternary ammonium salt group as the ion exchange group and a bis(trifluoromethanesulfonyl imide) ion as the counter ion.

Readiness of Ion Conducting Agent h:

Tetraethylammonium chloride was used as an ion conducting agent h.

### Example 1

1. Preparation of Electrically Conductive Layer Coating Solution:

0.735 g (0.988 mmol) of polyethylene glycol diglycidyl ether (mass-average molecular weight: 744) and 0.057 g (0.384 mmol) of ethylene glycol bis(2-aminoethyl) ether as compounds having the structure represented by the formula (1)-1, 1.169 g (0.835 mmol) of amine-terminated modified NBR (trade name: ATBN 1300X35; available from Ube Industries, Ltd.) as a compound having the structure represented by the formula (2)-1 and 0.039 g (2 parts by mass based on 100 parts by mass of the binder resin) of the ion conducting agent a were dissolved in isopropyl alcohol (IPA) to prepare a “coating solution 1” having a solid content of 27% by mass. Incidentally, n1 of the formula (1)-1 was 13, and [m1:p1] of the formula (2)-1 was 74:26.

2. Coating of Electrically Conductive Layer Coating Solution:

The elastic roller A was, with its lengthwise direction set in the vertical direction, dipped in the coating solution 1 to carry out dip coating. The dip coating was so carry out as for dipping time to be 9 seconds, and for dipping draw-up speed to be 20 mm/sec in initial-stage speed and 2 mm/sec in final speed, during which the speed was changed linearly with respect to time. The coated product obtained was air-dried at normal temperature for 30 minutes or more, thereafter heated at a temperature of 90° C. for 1 hour by means of a circulating hot-air drier, and further heated at a temperature of 160° C. for 3 hours by means of the circulating hot-air drier. Thus, a “conductive roller 1” was obtained, having the electrically conductive layer (surface layer) according to the present invention which was formed on the peripheral surface of the elastic layer.

The binder resin of the electrically conductive layer contained linking groups having the structures represented by the formulas (3)-1 and (3)-2 and molecular terminals having the structures represented by the formulas (5)-1 and (5)-2, and the structure represented by the formula (1)-1 was in a content of 30% by mass. The electrically conductive layer was in a layer thickness of 10 μm. Also, the binder resin did not make any matrix-domain structure form in the electrically conductive layer.

Evaluation 2: Measurement of Electrical Resistivity of Electrically Conductive Layer, and Evaluation on Environmental Dependence of Electrical Resistivity.

The electrical resistivity of the electrically conductive layer was calculated by measuring alternating-current impedance by four-terminal probing. The measurement was made in two environments, the L/L environment and the H/H environment. Before the measurement, the conductive member 1 was left to stand in each environment for 48 hours or more, and the electrical resistivity was measured at a voltage amplitude of 5 mV and a frequency of from 1 Hz to 1 MHz. Also, as the evaluation on environmental dependence of the electrical resistivity, the logarithm of the ratio of electrical resistivity R1 in the L/L environment to electrical resistivity R2 in the H/H environment, R1/R2, was calculated. The results of the measurement of electrical resistivity and the results of the evaluation on environmental dependence are shown in Table 7-1.

Evaluation 3: Evaluation on Bleeding.

The conductive member of this Example was brought into pressure contact with a polyethylene terephthalate (PET) sheet by pressing down the former's mandrel at a pressure of 500 gf on each end portion thereof (1,000 gf in total on both end portions), and this was left to stand in an environment of temperature: 40° C. and relative humidity: 95% for 2 weeks. After the leaving, the surface of the PET sheet was observed on an optical microscope (10 magnifications). Whether or not any bleeding occurred from the conductive member was observed to make evaluation according to the following criteria. The results of evaluation are shown in Table 7-1.

A: Any bled matter adhering is not seen on the PET sheet surface.
B: Slight bled matter adhering is seen on some part of the PET sheet surface.
C: Bled matter adhering is seen on the whole PET sheet surface.

Evaluation 4: Image Evaluation in Low-Temperature and Low-Humidity Environment, as Charging Roller.

Image evaluation in a low-temperature and low-humidity environment was made in the following way. A color laser beam printer (trade name: COLOR LASERJET CP3525n; manufactured by Hewlett-Packard Company) and a magenta electrophotographic process cartridge therefor were readied, and the conductive member of this Example was set as a charging roller into the electrophotographic process cartridge. The color laser beam printer and the electrophotographic process cartridge were left to stand in the L/L environment for 24 hours, and thereafter, as they were in the L/L environment, a halftone image (an image in which horizontal lines were each drawn in a width of 1 dot and at intervals of 2 dots in the direction perpendicular to the rotational direction of a photosensitive drum) was reproduced on 1 sheet. If the charging roller has come to have a high resistance in the low-temperature and low-humidity environment, streaky images tend to come. From the halftone image reproduced, evaluation was made on the streaky images according to the following criteria. The results of evaluation are shown in Table 7-1.

A: Any streaky images are not seen.
B: Slight streaky images are seen in some part.
C: Slight streaky images are seen over the whole area.
D: Serious streaky images are seen over the whole area.

Evaluation 5: Image Evaluation in High-Temperature and High-Humidity Environment, as Charging Roller.

Image evaluation in a high-temperature and high-humidity environment was made in the following way. A color laser beam printer (trade name: COLOR LASERJET CP3525n; manufactured by Hewlett-Packard Company) and a magenta electrophotographic process cartridge therefor were readied. From the electrophotographic process cartridge, a photosensitive drum was detached and a pinhole of 20 μm in diameter was made only in its charge transport layer at the surface of the photosensitive drum. The photosensitive drum having such a pinhole and the conductive member of this Example, used as a charging roller, were set into the electrophotographic process cartridge. The color laser beam printer and the electrophotographic process cartridge were left to stand in the H/H environment for 24 hours, and thereafter, as they were in the H/H environment, halftone images were reproduced on 10 sheets. If the charging roller has come to have a high resistance in the high-temperature and high-humidity environment, streaky images tend to come at the position of the pinhole on the photosensitive drum. From the halftone images reproduced, evaluation was made on the streaky images according to the following criteria. The results of evaluation are shown in Table 7-1.

A: Any streaky images are not seen in halftone images on all the 10 sheets.
B: Streaky images are seen in halftone images on 1 to 3 sheet(s) of the 10 sheets.
C: Streaky images are seen in halftone images on 4 or more sheets of the 10 sheets.

### Examples 2 to 47

Conductive rollers 2 to 47 were produced, and evaluated as charging rollers, in the same way as Example 1 except that, as raw materials for the electrically conductive layer, stated materials of those shown in Table 4 were used and the amounts of the materials used were changed to values shown in Tables 5-1 to 5-4. The results of evaluation are shown in Tables 7-1 to 7-5.

### Example 48

An electrically conductive member 48 was produced, and evaluated as a charging roller, in the same way as Example 1 except that the elastic roller A was changed for the elastic roller B. The results of evaluation are shown in Table 7-5.

### Example 49

An electrically conductive member 49 was produced in the same way as Example 1 except that the elastic roller A was changed for the elastic roller C; and this was evaluated as a developing roller in the following way. The results of evaluation are shown in Table 7-5.

Evaluation 6: Image Evaluation in Low-Temperature and Low-Humidity Environment, as Developing Roller.

Image evaluation in a low-temperature and low-humidity environment was made in the following way. A color laser beam printer (trade name: COLOR LASERJET CP3525n; manufactured by Hewlett-Packard Company) and a magenta electrophotographic process cartridge therefor were readied, and the conductive member of this Example was set as a developing roller into the electrophotographic process cartridge. The color laser beam printer and the electrophotographic process cartridge were left to stand in the L/L environment for 24 hours, and thereafter, as they were in the L/L environment, images of 2% in print area were reproduced on 10,000 sheets and finally a solid white image was reproduced on 1 sheet of glossy paper. If the developing roller has come to have a high resistance in the low-temperature and low-humidity environment, fog images may come.

The reflection densities of the solid white image reproduced were measured at its 16 spots (at the central points of 16 squares formed by dividing the glossy paper equally into 4 squares lengthways and 4 squares sideways), and their average value was represented by Ds (%) and the reflection density of the glossy paper before the solid white image was reproduced thereon was represented by Dr (%), were the value of Ds−Dr was taken as “fog level”. Here, these reflection densities were measured with a reflection densitometer (trade name: White Photometer TC-6DS/A; manufactured by Tokyo Denshoku Technical Center Company Ltd.). Fogged images were evaluated according to the following criteria. The results of evaluation are shown in Table 7-5.

A: The fog level is less than 0.5%.
B: The fog level is 0.5% or more to less than 2%.
C: The fog level is 2% or more to less than 5%.
D: The fog level is 5% or more.

Evaluation 7: Image Evaluation in High-Temperature and High-Humidity Environment, as Developing Roller.

Evaluation was made in the same way as “Evaluation 5” except that the conductive member of this Example was set not as a charging roller but as a developing roller into the electrophotographic process cartridge. The results of evaluation are shown in Table 7-5.

### Example 50

This Example is concerned with the conductive member shown in FIG. 1A, having the mandrel and provided on its peripheral surface the electrically conductive layer according to the present invention. An electrically conductive member 50 was produced, and evaluated as a charging roller, in the same way as Example 1 except that a mandrel of 8 mm in diameter was directly coated thereon with the coating solution 1. The results of evaluation are shown in Table 7-5.

### Example 51

An electrically conductive member 51 was produced, and evaluated as a charging roller, in the same way as Example 1 except that the electrically conductive layer was formed in a layer thickness of 2 μm. The results of evaluation are shown in Table 7-6.

### Example 52

An electrically conductive member 52 was produced, and evaluated as a charging roller, in the same way as Example 1 except that the electrically conductive layer was formed in a layer thickness of 100 μm. The results of evaluation are shown in Table 7-6.

### Example 53

This Example is concerned with the conductive roller shown in FIG. 1C, having the mandrel and provided on its peripheral surface the elastic layer, the intermediate layer (the electrically conductive layer in the present invention) and the surface layer in this order.

1. Preparation of Surface Layer Coating Fluid:

To an ∈-caprolactone modified acrylic polyol solution (trade name: PLACCEL DC2016, available from Daicel Chemical Industries, Ltd.), methyl isobutyl ketone (MIBK) was added to dilute the former so as to be 19% by mass in solid content. Into 526.3 parts by mass of the dilute solution obtained (100 parts by mass of the acrylic polyol solid content), 45 parts by mass of carbon black (trade name: MA100; available from Mitsubishi Chemical Corporation), 0.08 part by mass of modified dimethylsilicone oil (trade name: SH28PA; available from Dow Corning Toray Silicone Co., Ltd.), 80.14 parts by mass of a blocked isocyanate mixture were mixed. Incidentally, the blocked isocyanate mixture is a 7:3 mixture of hexamethylene diisocyanate (trade name: DURANATE TPA-B80E; available from Asahi Chemical Industry Co. Ltd.) and isophorone diisocyanate (trade name: BESTANATO B1370; available from Degussa-Hulls AG).

200 g of the mixture solution obtained above was put into a glass bottle of 450 ml in volume together with 200 g of glass beads of 0.8 mm in average particle diameter as dispersion media, followed by dispersion for 100 hours by using a paint shaker dispersion machine. After the dispersion, the glass beads were removed to obtain a “coating fluid 2” for surface layer.

2. Coating of Surface Layer Coating Fluid:

An electrically conductive member obtained in the same way as Example 1 was coated on its peripheral surface with the above coating fluid by dipping in the same way as Example 1. The coated product obtained was air-dried at normal temperature for 30 minutes or more, thereafter heated at a temperature of 80° C. for 1 hour by means of a circulating hot-air drier, and further heated at a temperature of 160° C. for 1 hour by means of the circulating hot-air drier, to form a surface layer on the peripheral surface of the conductive roller 1.

Thus, a conductive roller 53 was produced, constituted of the conductive roller 1 according to Example 1 and provided on the peripheral surface thereof the surface layer, and evaluated as a charging roller. The results of evaluation are shown in Table 7-6.

### Example 54

An electrically conductive member 54 was produced in the same way as Example 1, and this was evaluated as a transfer roller.

Evaluation 8: Image Evaluation as Transfer Roller.

Image evaluation was made in the following way. A color laser beam printer (trade name: COLOR LASERJET CP3525n; manufactured by Hewlett-Packard Company) and a magenta electrophotographic process cartridge therefor were readied, and the conductive member of this Example was set as a transfer roller into the color laser beam printer, where images were reproduced. The color laser beam printer and the electrophotographic process cartridge were left to stand in the L/L environment for 24 hours, and thereafter, as they were in the L/L environment, images of 2% in print area were reproduced on 10,000 sheets and finally a halftone image was reproduced on 1 sheet. The halftone image formed was evaluated according to the following criteria. The results of evaluation are shown in Table 7-4. The image was also evaluated in the H/H environment in the same way as in the L/L environment. The results of evaluation are shown in Table 7-6.

A: The image is a good halftone image without any problem.
B: Some toner is not transferred to the intermediate transfer belt, so that the halftone image is partly broken.
C: The toner is not transferred at all to the intermediate transfer belt, so that the halftone image is not reproduced.

### Examples 55 & 56

Conductive rollers 55 and 56 were produced, and evaluated as charging rollers, in the same way as Example 1 except that, as raw materials for the electrically conductive layer, stated materials of those shown in Table 4 were used and the amounts of the materials used were changed to values shown in Table 5-5. The results of evaluation are shown in Table 7-6.

### Example 57

0.209 g (0.281 mmol) of polyethylene glycol diglycidyl ether (mass-average molecular weight: 744) as a compound having the structure represented by the formula (1)-1, 0.983 g (0.281 mmol) of carboxy-terminated modified NBR (trade name: CTBN 1300X13; available from Ube Industries, Ltd.) as a compound having the structure represented by the formula (2)-1 and 0.012 g triphenylphosphine were mixed, and then stirred at a temperature of 120° C. for 2 hours, followed by cooling to room temperature. To the reaction solution obtained, 0.572 g (0.768 mmol) of polyethylene glycol diglycidyl ether (mass-average molecular weight: 744) as a compound having the structure represented by the formula (1)-1, 0.039 g (2 parts by mass based on 100 parts by mass of the binder resin) of the ion conducting agent a, 0.198 g (0.477 mmol) of an acid anhydride type curing agent (trade name: RIKACID TMEG-500; available from New Japan Chemical Co., Ltd.) and 0.04 g of 1-benzyl-2-methylimidazole (trade name: CUREZOL 1B2MZ; available from Shikoku Chemicals Corp.) as a curing accelerator were added and dissolved in toluene to prepare a “coating solution 3” having a solid content of 27% by mass. Incidentally, n1 of the formula (1)-1 was 13, and m1:p1 of the formula (2)-1 was 74:26.

Operations subsequent to the coating of the coating solution in Example 1 were repeated to produce a conductive roller 57, which was evaluated as a charging roller in the same way. The results of evaluation are shown in Table 7-6.

### Example 58

A conductive roller 58 was produced, and evaluated as a charging roller, in the same way as Example 1 except that, as raw materials for the electrically conductive layer, stated materials of those shown in Table 4 were used and the amounts of the materials used were changed to values shown in Table 5-5. The results of evaluation are shown in Table 7-6.

### Example 59

0.506 g (1.150 mmol) of polyether amine (trade name: JEFAMIN T-403; available from Huntsman International LLC.) as a compound having the structure represented by the formula (1)-2 and 0.586 g (0.418 mmol) of amino-terminated modified NBR (trade name: ATBN 1300X35; available from Ube Industries, Ltd.) as a compound having the structure represented by the formula (2)-1 were mixed. Further, 0.039 g (2 parts by mass based on 100 parts by mass of the binder resin) of the ion conducting agent a, 0.869 g (2.095 mmol) of an acid anhydride type curing agent (trade name: RIKACID TMEG-500; available from New Japan Chemical Co., Ltd.) and toluene were added to prepare a “coating solution 4” having a solid content of 27% by mass. Incidentally, n1 of the formula (1)-1 was 13, and m1:p1 of the formula (2)-1 was 74:26.

Operations subsequent to the coating of the coating solution in Example 1 were repeated to produce a conductive roller 59, which was evaluated as a charging roller in the same way. The results of evaluation are shown in Table 7-6.

### Example 60

1. Preparation of Electrically Conductive Layer Coating Solution:

0.621 g (1.137 mmol) of polyethylene glycol (mass-average molecular weight: 744) as a compound having the structure represented by the formula (1)-1, 1.013 g (0.724 mmol) of amine-terminated modified NBR (trade name: ATBN 1300X35; available from Ube Industries, Ltd.) as a compound having the structure represented by the formula (2)-1, 0.039 g (2 parts by mass based on 100 parts by mass of the binder resin) of the ion conducting agent g and 0.327 g of a polyfunctional type isocyanate (trade name: MILLIONATE MR-200; available from Nippon Polyurethane Industry Co., Ltd.) were dissolved in methyl ethyl ketone (MEK) to prepare a “coating solution 5” having a solid content of 35% by mass. Incidentally, n1 of the formula (1)-1 was 12, and m1:p1 of the formula (2)-1 was 74:26.

2. Coating of Electrically Conductive Layer Coating Solution:

The elastic roller A was coated with the above coating solution by dip coating in the same way as Example 1. The coated product obtained was air-dried at normal temperature for 30 minutes or more, and thereafter heated at a temperature of 140° C. for 2 hours by means of a circulating hot-air drier. Thus, an electrically conductive layer was formed on the peripheral surface of the elastic roller A to obtain a conductive roller 60.

The binder resin of the electrically conductive layer contained linking groups of compounds having the structures represented by the formulas (3)-6 and (3)-8 and a molecular terminal of a compound having the structure represented by the formula (5)-6, and the compound having the structure represented by the formula (1)-1 was in a content of 30% by mass. The electrically conductive layer was in a layer thickness of 10 μm. Also, the binder resin did not make any matrix-domain structure form in the electrically conductive layer. This conductive roller 60 was evaluated as a charging roller to obtain the results shown in Table 7-6.

### Examples 61 to 68

Electrically conductive rollers 61 to 68 were produced in the same way as Example 54 except that the elastic layers, the raw materials for the electrically conductive layers and the used amount thereof are changed to those as shown in Table 4 and Table 5-6. Then, the electrically conductive rollers 61 to 68 were evaluated as charging rollers. The results of evaluation are shown in Table 7-7.

### Example 69

An electrically conductive roller 69 was produced in the same way as Example 54 except that the elastic layer, the raw materials for the electrically conductive layer and used amount thereof were changed to those as shown in Table 4 and Table 5-6. Then, the electrically conductive roller 69 was evaluated as a developing roller. The results of evaluation are shown in Table 7-7.

### Example 70

This Example is concerned with the conductive member shown in FIG. 1A, having the mandrel and provided on its peripheral surface the electrically conductive layer according to the present invention. An electrically conductive member 70 was produced, and evaluated as a charging roller, in the same way as Example 54 except that a mandrel of 8 mm in diameter was directly coated thereon with the coating solution. The results of evaluation are shown in Table 7-7.

### Comparative Examples 1 to 3

Conductive rollers C1 to C3 were produced, and evaluated as charging rollers, in the same way as Example 1 except that, as the raw materials for the electrically conductive layer, stated materials of those shown in Table 4 were used in amounts changed as shown in Table 8. The results of evaluation are shown in Table 8.

### Comparative Example 4

0.451 g (0.322 mmol) of amino-terminated modified NBR (trade name: ATBN 1300X35; available from Ube Industries, Ltd.) and 1.223 g (0.322 mmol) of carboxy-terminated modified NBR (trade name: CTBN 1300X13; available from Ube Industries, Ltd.) as compounds having the structure represented by the formula (2)-1 were dissolved in toluene, and these were stirred at a temperature of 120° C. for 2 hours, followed by cooling to room temperature. To the reaction solution obtained, 0.239 g (0.322 mmol) of polyethylene glycol diglycidyl ether (mass-average molecular weight: 744) and 0.048 g (0.322 mmol) of ethylene glycol bis(2-aminoethyl)ether as compounds having the structure represented by the formula (1)-1, and 0.039 g (2 parts by mass based on 100 parts by mass of the binder resin) of the ion conducting agent a were mixed, followed by addition of toluene so as for the resultant solution have a solid content of 27% by mass to prepare a “coating solution 6”. Incidentally, n1 of the formula (1)-1 was 13, and m1:p1 of the formula (2)-1 was 74:26.

The procedure subsequent to the coating of the coating solution in Example 1 was repeated to produce a conductive roller C4, which was evaluated as a charging roller in the same way. The results of evaluation are shown in Table 8.

TABLE 4

| | | Molecular |
|---|---|---|
| Symbol | Materials | wt. |
| D | Polyethylene glycol diglycidyl ether | 744 |
| E | Ethylene glycol diglycidyl ether | 174 |
| F | Polyethylene glycol diglycidyl ether | 526 |
| G | Polyethylene glycol diglycidyl ether | 1,102 |
| H | Polyethylene glycol | 600 |
| I | Polypropylene glycol diglycidyl ether | 380 |
| J | Polypropylene glycol diglycidyl ether | 640 |
| K | Polypropylene glycol diglycidyl ether | 942 |
| L | Polyether amine (trade name: JEFAMIN T-403; | 440 |
| | available from Huntsman) | |
| M | Tetramethylene glycol diglycidyl ether | 202 |
| N | Polytetramethylene glycol diglycidyl ether | 870 |
| O | Ethylene glycol bis(2-aminoethyl) ether | 148 |
| P | Polypropylene glycol bis(2-aminopropyl) ether | 400 |
| Q | Ethylene glycol bis(2-mercaptoethyl) ether | 182 |
| R | Amino-terminated modified NBR (trade name: | 1,400 |
| | ATBN 1300X35; available from Ube Industries) | |
| S | Amino-terminated modified NBR (trade name: | 1,800 |
| | ATBN 1300X16; available from Ube Industries) | |
| T | Amino-terminated modified NBR (trade name: | 2,400 |
| | ATBN 1300X21; available from Ube Industries) | |
| U | Hydrogenated product of amino-terminated | 1,400 |
| | modified NBR (trade name: ATBN 1300X35; | |
| | available from Ube Industries) | |
| V | Epoxy-terminated modified NBR (trade name: | 3,800 |
| | ETBN 1300X63; available from Emerald | |
| | Performance Materials) | |
| W | Hydrogenated product of epoxy-terminated | 3,800 |
| | modified NBR (trade name: ETBN 1300X63; | |
| | available from Emerald Performance Materials) | |
| X | Carboxy-terminated modified NBR (trade name: | 3,500 |
| | CTBN 1300X13; available from Ube Industries) | |
| Y | Acid anhydride type curing agent (trade name: | 415 |
| | RIKACID TMEG-500; available from New Japan | |
| | Chemical) | |
| Z | polyfunctional type isocyanate (trade name: | 136 |
| | MILLIONATE MR-200; available from Nippon | (NCO |
| | Polyurethane Industry) | group |
| | | value) |
| α | 1,8-Diaminooctane | 144 |

TABLE 5-1

| Example No.: | 1 | 2 | 3 | 4 | 5 | 6 | 7 | 8 | 9 | 10 | 11 | 12 |
|---|---|---|---|---|---|---|---|---|---|---|---|---|
| Elastic roller | A | A | A | A | A | A | A | A | A | A | A | A |
| Formula-(1) material | D | E | F | G | D | D | D | D | D | D | D | D |
| Chemical formula | (1)-1 | (1)-1 | (1)-1 | (1)-1 | (1)-1 | (1)-1 | (1)-1 | (1)-1 | (1)-1 | (1)-1 | (1)-1 | (1)-1 |
| n1 or n2 or n3 | 13 | 1 | 9 | 22 | 13 | 13 | 13 | 13 | 13 | 13 | 13 | 13 |
| Number of moles (mmol) | 0.988 | 5.508 | 1.372 | 0.615 | 0.355 | 0.690 | 1.291 | 1.595 | 2.199 | 0.679 | 0.975 | 1.581 |
| Amount (g) | 0.735 | 0.958 | 0.721 | 0.678 | 0.264 | 0.513 | 0.960 | 1.187 | 1.636 | 0.505 | 0.725 | 1.176 |
| Formula-(1) material | O | O | O | O | O | O | O | O | O | O | O | O |
| Chemical formula | (1)-1 | (1)-1 | (1)-1 | (1)-1 | (1)-1 | (1)-1 | (1)-1 | (1)-1 | (1)-1 | (1)-1 | (1)-1 | (1)-1 |
| n1 or n2 or n3 | 2 | 2 | 2 | 2 | 2 | 2 | 2 | 2 | 2 | 2 | 2 | 2 |
| Number of moles (mmol) | 0.384 | 4.080 | 0.663 | 0.063 | 0.003 | 0.056 | 0.682 | 1.002 | 1.645 | 0.162 | 0.470 | 1.087 |
| Amount (g) | 0.057 | 0.605 | 0.098 | 0.009 | 0.0005 | 0.008 | 0.101 | 0.148 | 0.244 | 0.024 | 0.070 | 0.161 |
| Formula-(1) content | 30 | 30 | 30 | 30 | 10 | 20 | 40 | 50 | 70 | 20 | 30 | 50 |
| (% by mass) | | | | | | | | | | | | |
| Formula-(2) material | R | R | R | R | R | R | R | R | R | S | S | S |
| Chemical formula | (2)-1 | (2)-1 | (2)-1 | (2)-1 | (2)-1 | (2)-1 | (2)-1 | (2)-1 | (2)-1 | (2)-1 | (2)-1 | (2)-1 |
| m1:p1 or m2:p2 | 74:26 | 74:26 | 74:26 | 74:26 | 74:26 | 74:26 | 74:26 | 74:26 | 74:26 | 82:18 | 82:18 | 82:18 |
| Number of moles (mmol) | 0.835 | 0.284 | 0.815 | 0.909 | 1.212 | 1.028 | 0.642 | 0.447 | 0.058 | 0.796 | 0.647 | 0.346 |
| Amount (g) | 1.169 | 0.398 | 1.141 | 1.273 | 1.696 | 1.439 | 0.899 | 0.626 | 0.081 | 1.432 | 1.165 | 0.623 |
| Ion conducting agent | a. | a. | a. | a. | a. | a. | a. | a. | a. | a. | a. | a. |
| Amount (g) | 0.039 | 0.039 | 0.039 | 0.039 | 0.039 | 0.039 | 0.039 | 0.039 | 0.039 | 0.039 | 0.039 | 0.039 |
| Amount (parts by mass) | 2 | 2 | 2 | 2 | 2 | 2 | 2 | 2 | 2 | 2 | 2 | 2 |
| Other material | No | No | No | No | No | No | No | No | No | No | No | No |
| Amount (g) | — | — | — | — | — | — | — | — | — | — | — | — |
| Formula-(3) materials, | (3)-1 | (3)-1 | (3)-1 | (3)-1 | (3)-1 | (3)-1 | (3)-1 | (3)-1 | (3)-1 | (3)-1 | (3)-1 | (3)-1 |
| chemical formulas | (3)-2 | (3)-2 | (3)-2 | (3)-2 | (3)-2 | (3)-2 | (3)-2 | (3)-2 | (3)-2 | (3)-2 | (3)-2 | (3)-2 |
| Formula-(4) material, | No | No | No | No | No | No | No | No | No | No | No | No |
| chemical formula | | | | | | | | | | | | |
| Formula-(5) materials, | (5)-1 | (5)-1 | (5)-1 | (5)-1 | (5)-1 | (5)-1 | (5)-1 | (5)-1 | (5)-1 | (5)-1 | (5)-1 | (5)-1 |
| chemical formulas | (5)-2 | (5)-2 | (5)-2 | (5)-2 | (5)-2 | (5)-2 | (5)-2 | (5)-2 | (5)-2 | (5)-2 | (5)-2 | (5)-2 |

TABLE 5-2

| Example No.: | 13 | 14 | 15 | 16 | 17 | 18 | 19 | 20 | 21 | 22 | 23 | 24 |
|---|---|---|---|---|---|---|---|---|---|---|---|---|
| Elastic roller | A | A | A | A | A | A | A | A | A | A | A | A |
| Formula-(1) material | D | D | D | D | D | I | J | K | K | K | K | K |
| Chemical formula | (1)-1 | (1)-1 | (1)-1 | (1)-1 | (1)-1 | (1)-2 | (1)-2 | (1)-2 | (1)-2 | (1)-2 | (1)-2 | (1)-2 |
| n1 or n2 or n3 | 13 | 13 | 13 | 13 | 13 | 4 | 6 | 11 | 11 | 11 | 11 | 11 |
| Number of moles (mmol) | 2.187 | 0.660 | 0.968 | 1.577 | 2.187 | 1.480 | 1.172 | 0.800 | 0.312 | 1.185 | 1.534 | 0.778 |
| Amount (g) | 1.627 | 0.491 | 0.720 | 1.173 | 1.627 | 0.562 | 0.750 | 0.754 | 0.294 | 1.116 | 1.445 | 0.733 |
| Formula-(1) material | O | O | O | O | O | P | P | P | P | P | P | P |
| Chemical formula | (1)-1 | (1)-1 | (1)-1 | (1)-1 | (1)-1 | (1)-2 | (1)-2 | (1)-2 | (1)-2 | (1)-2 | (1)-2 | (1)-2 |
| n1 or n2 or n3 | 2 | 2 | 2 | 2 | 2 | 6 | 6 | 6 | 6 | 6 | 6 | 6 |
| Number of moles (mmol) | 1.682 | 0.246 | 0.535 | 1.101 | 1.690 | 0.782 | 0.586 | 0.272 | 0.002 | 0.745 | 1.266 | 0.316 |
| Amount (g) | 0.249 | 0.037 | 0.079 | 0.163 | 0.250 | 0.313 | 0.234 | 0.109 | 0.001 | 0.298 | 0.506 | 0.126 |
| Formula-(1) content | 70 | 20 | 30 | 50 | 70 | 30 | 30 | 30 | 10 | 50 | 70 | 30 |
| (% by mass) | | | | | | | | | | | | |
| Formula-(2) material | S | T | T | T | T | R | R | R | R | R | R | S |
| Chemical formula | (2)-1 | (2)-1 | (2)-1 | (2)-1 | (2)-1 | (2)-1 | (2)-1 | (2)-1 | (2)-1 | (2)-1 | (2)-1 | (2)-1 |
| m1:p1 or m2:p2 | 82:18 | 90:10 | 90:10 | 90:10 | 90:10 | 74:26 | 74:26 | 74:26 | 74:26 | 74:26 | 74:26 | 82:18 |
| Number of moles (mmol) | 0.047 | 0.597 | 0.484 | 0.260 | 0.035 | 0.775 | 0.698 | 0.784 | 1.190 | 0.390 | 0.007 | 0.612 |
| Amount (g) | 0.084 | 1.433 | 1.162 | 0.624 | 0.083 | 1.085 | 0.977 | 1.098 | 1.666 | 0.547 | 0.009 | 1.101 |
| Ion conducting agent | a. | a. | a. | a. | a. | a. | a. | a. | a. | a. | a. | a. |
| Amount (g) | 0.039 | 0.039 | 0.039 | 0.039 | 0.039 | 0.039 | 0.039 | 0.039 | 0.039 | 0.039 | 0.039 | 0.039 |
| Amount (parts by mass) | 2 | 2 | 2 | 2 | 2 | 2 | 2 | 2 | 2 | 2 | 2 | 2 |
| Other material | No | No | No | No | No | No | No | No | No | No | No | No |
| Amount (g) | — | — | — | — | — | — | — | — | — | — | — | — |
| Formula-(3) materials, | (3)-1 | (3)-1 | (3)-1 | (3)-1 | (3)-1 | (3)-1 | (3)-1 | (3)-1 | (3)-1 | (3)-1 | (3)-1 | (3)-1 |
| chemical formulas | (3)-2 | (3)-2 | (3)-2 | (3)-2 | (3)-2 | (3)-2 | (3)-2 | (3)-2 | (3)-3 | (3)-4 | (3)-5 | (3)-2 |
| Formula-(4) material, | No | No | No | No | No | No | No | No | No | No | No | No |
| chemical formula | | | | | | | | | | | | |
| Formula-(5) materials, | (5)-1 | (5)-1 | (5)-1 | (5)-1 | (5)-1 | (5)-1 | (5)-1 | (5)-1 | (5)-1 | (5)-1 | (5)-1 | (5)-1 |
| chemical formulas | (5)-2 | (5)-2 | (5)-2 | (5)-2 | (5)-2 | (5)-2 | (5)-2 | (5)-2 | (5)-3 | (5)-4 | (5)-5 | (5)-2 |

TABLE 5-3

| Example No.: | 25 | 26 | 27 | 28 | 29 | 30 | 31 | 32 | 33 | 34 | 35 | 36 |
|---|---|---|---|---|---|---|---|---|---|---|---|---|
| Elastic roller | A | A | A | A | A | A | A | A | A | A | A | A |
| Formula-(1) material | K | M | N | N | N | N | N | N | D | D | D | N |
| Chemical formula | (1)-2 | (1)-3 | (1)-3 | (1)-3 | (1)-3 | (1)-3 | (1)-3 | (1)-3 | (1)-1 | (1)-1 | (1)-1 | (1)-3 |
| n1 or n2 or n3 | 11 | 1 | 10 | 10 | 10 | 10 | 10 | 10 | 13 | 13 | 13 | 10 |
| Number of moles (mmol) | 0.748 | 2.140 | 0.757 | 0.276 | 1.098 | 1.414 | 0.725 | 0.693 | 0.985 | 0.969 | 0.988 | 0.757 |
| Amount (g) | 0.705 | 0.432 | 0.659 | 0.240 | 0.955 | 1.230 | 0.631 | 0.603 | 0.733 | 0.721 | 0.735 | 0.659 |
| Formula-(1) material | P | P | P | P | P | P | P | P | O | O | O | P |
| Chemical formula | (1)-2 | (1)-2 | (1)-2 | (1)-2 | (1)-2 | (1)-2 | (1)-2 | (1)-2 | (1)-1 | (1)-1 | (1)-1 | (1)-2 |
| n1 or n2 or n3 | 6 | 6 | 6 | 6 | 6 | 6 | 6 | 6 | 2 | 2 | 2 | 6 |
| Number of moles (mmol) | 0.374 | 1.360 | 0.166 | 0.003 | 0.638 | 1.165 | 0.238 | 0.309 | 0.416 | 0.514 | 0.384 | 0.166 |
| Amount (g) | 0.150 | 0.544 | 0.067 | 0.001 | 0.255 | 0.466 | 0.095 | 0.124 | 0.062 | 0.076 | 0.057 | 0.067 |
| Formula-(1) content | 30 | 30 | 30 | 10 | 50 | 70 | 30 | 30 | 30 | 30 | 30 | 30 |
| (% by mass) | | | | | | | | | | | | |
| Formula-(2) material | T | R | R | R | R | R | S | T | R | R | U | U |
| Chemical formula | (2)-1 | (2)-1 | (2)-1 | (2)-1 | (2)-1 | (2)-1 | (2)-1 | (2)-1 | (2)-1 | (2)-1 | (2)-2 | (2)-2 |
| m1:p1 or m2:p2 | 90:10 | 74:26 | 74:26 | 74:26 | 74:26 | 74:26 | 82:18 | 90:10 | 74:26 | 74:26 | 74:26 | 74:26 |
| Number of moles (mmol) | 0.461 | 0.703 | 0.882 | 1.228 | 0.536 | 0.189 | 0.686 | 0.515 | 0.806 | 0.753 | 0.835 | 0.882 |
| Amount (g) | 1.106 | 0.984 | 1.235 | 1.719 | 0.750 | 0.264 | 1.235 | 1.235 | 1.129 | 1.055 | 1.169 | 1.235 |
| Ion conducting agent | a. | a. | a. | a. | a. | a. | a. | a. | a. | a. | a. | a. |
| Amount (g) | 0.039 | 0.039 | 0.039 | 0.039 | 0.039 | 0.039 | 0.039 | 0.039 | 0.077 | 0.148 | 0.039 | 0.039 |
| Amount (parts by mass) | 2 | 2 | 2 | 2 | 2 | 2 | 2 | 2 | 4 | 8 | 2 | 2 |
| Other material | No | No | No | No | No | No | No | No | No | No | No | No |
| Amount (g) | — | — | — | — | — | — | — | — | — | — | — | — |
| Formula-(3) materials, | (3)-1 | (3)-1 | (3)-1 | (3)-1 | (3)-1 | (3)-1 | (3)-1 | (3)-1 | (3)-1 | (3)-1 | (3)-1 | (3)-1 |
| chemical formulas | (3)-2 | (3)-2 | (3)-2 | (3)-3 | (3)-4 | (3)-5 | (3)-2 | (3)-2 | (3)-2 | (3)-2 | (3)-2 | (3)-2 |
| Formula-(4) material, | No | No | No | No | No | No | No | No | No | No | No | No |
| chemical formula | | | | | | | | | | | | |
| Formula-(5) materials, | (5)-1 | (5)-1 | (5)-1 | (5)-1 | (5)-1 | (5)-1 | (5)-1 | (5)-1 | (5)-1 | (5)-1 | (5)-1 | (5)-1 |
| chemical formulas | (5)-2 | (5)-2 | (5)-2 | (5)-3 | (5)-4 | (5)-5 | (5)-2 | (5)-2 | (5)-2 | (5)-2 | (5)-2 | (5)-2 |

TABLE 5-4

| Example No.: | 37 | 38 | 39 | 40 | 41 | 42 | 43 | 44 | 45 | 46 | 47 | 48 |
|---|---|---|---|---|---|---|---|---|---|---|---|---|
| Elastic roller | A | A | A | A | A | A | A | A | A | A | A | B |
| Formula-(1) material | D | D | N | D | N | D | N | D | N | D | N | D |
| Chemical formula | (1)-1 | (1)-1 | (1)-3 | (1)-1 | (1)-3 | (1)-1 | (1)-3 | (1)-1 | (1)-3 | (1)-1 | (1)-3 | (1)-1 |
| n1 or n2 or n3 | 13 | 13 | 10 | 13 | 10 | 13 | 10 | 13 | 10 | 13 | 10 | 13 |
| Number of moles (mmol) | 0.980 | 2.185 | 0.735 | 0.987 | 0.745 | 0.994 | 0.761 | 1.016 | 0.800 | 1.004 | 0.780 | 0.988 |
| Amount (g) | 0.729 | 1.626 | 0.640 | 0.734 | 0.648 | 0.740 | 0.662 | 0.756 | 0.696 | 0.747 | 0.679 | 0.735 |
| Formula-(1) material | O | O | P | O | P | O | P | O | P | O | P | O |
| Chemical formula | (1)-1 | (1)-1 | (1)-2 | (1)-1 | (1)-2 | (1)-1 | (1)-2 | (1)-1 | (1)-2 | (1)-1 | (1)-2 | (1)-1 |
| n1 or n2 or n3 | 2 | 2 | 6 | 2 | 6 | 2 | 6 | 2 | 6 | 2 | 6 | 2 |
| Number of moles (mmol) | 0.443 | 1.713 | 0.216 | 0.399 | 0.194 | 0.360 | 0.158 | 0.213 | 0.073 | 0.293 | 0.117 | 0.384 |
| Amount (g) | 0.066 | 0.254 | 0.086 | 0.059 | 0.078 | 0.053 | 0.063 | 0.032 | 0.029 | 0.043 | 0.047 | 0.057 |
| Formula-(1) content | 30 | 70 | 30 | 30 | 30 | 30 | 30 | 30 | 30 | 30 | 30 | 30 |
| (% by mass) | | | | | | | | | | | | |
| Formula-(2) material | R | R | R | R | R | R | R | R | R | R | R | R |
| Chemical formula | (2)-1 | (2)-1 | (2)-1 | (2)-1 | (2)-1 | (2)-1 | (2)-1 | (2)-1 | (2)-1 | (2)-1 | (2)-1 | (2)-1 |
| m1:p1 or m2:p2 | 74:26 | 74:26 | 74:26 | 74:26 | 74:26 | 74:26 | 74:26 | 74:26 | 74:26 | 74:26 | 74:26 | 74:26 |
| Number of moles (mmol) | 0.833 | 0.058 | 0.882 | 0.834 | 0.882 | 0.834 | 0.882 | 0.838 | 0.882 | 0.836 | 0.882 | 0.835 |
| Amount (g) | 1.166 | 0.081 | 1.235 | 1.168 | 1.235 | 1.167 | 1.235 | 1.173 | 1.235 | 1.170 | 1.235 | 1.169 |
| Ion conducting agent | b. | b. | b. | c. | c. | d. | d. | e. | e. | f. | f. | a. |
| Amount (g) | 0.039 | 0.039 | 0.039 | 0.039 | 0.039 | 0.039 | 0.039 | 0.039 | 0.039 | 0.077 | 0.039 | 0.039 |
| Amount (parts by mass) | 2 | 2 | 2 | 2 | 2 | 2 | 2 | 2 | 2 | 4 | 2 | 2 |
| Other material | No | No | No | No | No | No | No | No | No | No | No | No |
| Amount (g) | — | — | — | — | — | — | — | — | — | — | — | — |
| Formula-(3) materials, | (3)-1 | (3)-1 | (3)-1 | (3)-1 | (3)-1 | (3)-1 | (3)-1 | (3)-1 | (3)-1 | (3)-1 | (3)-1 | (3)-1 |
| chemical formulas | (3)-2 | (3)-2 | (3)-2 | (3)-2 | (3)-2 | (3)-2 | (3)-2 | (3)-2 | (3)-2 | (3)-2 | (3)-2 | (3)-2 |
| Formula-(4) material, | No | No | No | No | No | No | No | Yes | Yes | Yes | Yes | No |
| chemical formula | | | | | | | | | | | | |
| Formula-(5) materials, | (5)-1 | (5)-1 | (5)-1 | (5)-1 | (5)-1 | (5)-1 | (5)-1 | (5)-1 | (5)-1 | (5)-1 | (5)-1 | (5)-1 |
| chemical formulas | (5)-2 | (5)-2 | (5)-2 | (5)-2 | (5)-2 | (5)-2 | (5)-2 | | | | | (5)-2 |

TABLE 5-5

| Example No.: | 49 | 50 | 51 | 52 | 53 | 54 | 55 | 56 | 57 | 58 | 59 | 60 |
|---|---|---|---|---|---|---|---|---|---|---|---|---|
| Elastic roller | C | No | A | A | A | A | A | A | A | A | A | A |
| Formula-(1) material | D | D | D | D | D | D | H | Q | D | H | N | H |
| Chemical formula | (1)-1 | (1)-1 | (1)-1 | (1)-1 | (1)-1 | (1)-1 | (1)-1 | (1)-1 | (1)-1 | (1)-1 | (1)-2 | (1)-1 |
| n1 or n2 or n3 | 13 | 13 | 13 | 13 | 13 | 13 | 12 | 2 | 13 | 12 | 6 | 12 |
| Number of moles (mmol) | 0.988 | 0.988 | 0.988 | 0.988 | 0.988 | 0.988 | 0.340 | 1.108 | 1.049 | 0.328 | 1.150 | 1.137 |
| Amount (g) | 0.735 | 0.735 | 0.735 | 0.735 | 0.735 | 0.735 | 0.185 | 0.202 | 0.781 | 0.179 | 0.506 | 0.621 |
| Formula-(1) material | O | P | O | O | O | O | O | P | No | P | No | No |
| Chemical formula | (1)-1 | (1)-2 | (1)-1 | (1)-1 | (1)-1 | (1)-1 | (1)-1 | (1)-2 | No | (1)-2 | No | No |
| n1 or n2 or n3 | 2 | 6 | 2 | 2 | 2 | 2 | 2 | 6 | — | 6 | — | — |
| Number of moles (mmol) | 0.384 | 0.384 | 0.384 | 0.384 | 0.384 | 0.384 | 0.233 | 0.037 | — | 0.295 | — | — |
| Amount (g) | 0.057 | 0.057 | 0.057 | 0.057 | 0.057 | 0.057 | 0.035 | 0.006 | — | 0.044 | — | — |
| Formula-(1) content | 30 | 30 | 30 | 30 | 30 | 30 | 10 | 5 | 30 | 10 | 30 | 30 |
| (% by mass) | | | | | | | | | | | | |
| Formula-(2) material | R | R | R | R | R | R | V | V | X | V | R | R |
| Chemical formula | (2)-1 | (2)-1 | (2)-1 | (2)-1 | (2)-1 | (2)-1 | (2)-1 | (2)-1 | (2)-1 | (2)-1 | (2)-1 | (2)-1 |
| m1:p1 or m2:p2 | 74:26 | 74:26 | 74:26 | 74:26 | 74:26 | 74:26 | 74:26 | 74:26 | 74:26 | 74:26 | 74:26 | 74:26 |
| Number of moles (mmol) | 0.835 | 0.835 | 0.835 | 0.835 | 0.835 | 0.835 | 0.458 | 0.461 | 0.281 | 0.457 | 0.418 | 0.724 |
| Amount (g) | 1.169 | 1.169 | 1.169 | 1.169 | 1.169 | 1.169 | 1.741 | 1.753 | 0.983 | 1.738 | 0.586 | 1.013 |
| Ion conducting agent | a. | a. | a. | a. | a. | a. | a. | a. | a. | a. | a. | g. |
| Amount (g) | 0.039 | 0.039 | 0.039 | 0.039 | 0.039 | 0.039 | 0.039 | 0.039 | 0.039 | 0.039 | 0.039 | 0.039 |
| Amount (parts by mass) | 2 | 2 | 2 | 2 | 2 | 2 | 2 | 2 | 2 | 2 | 2 | 2 |
| Other material | No | No | No | No | No | No | No | No | X | No | X | Y |
| Amount (g) | — | — | — | — | — | — | — | — | 0.198 | — | 0.869 | 0.327 |
| Formula-(3) materials, | (3)-1 | (3)-1 | (3)-1 | (3)-1 | (3)-1 | (3)-1 | (3)-1 | (3)-1 | (3)-3 | (3)-1 | No | (3)-6 |
| chemical formulas | (3)-2 | (3)-2 | (3)-2 | (3)-2 | (3)-2 | (3)-2 | (3)-4 | (3)-5 | (3)-4 | (3)-4 | | (3)-8 |
| Formula-(4) material, | No | No | No | No | No | No | No | No | No | No | No | No |
| chemical formula | | | | | | | | | | | | |
| Formula-(5) materials, | (5)-1 | (5)-1 | (5)-1 | (5)-1 | (5)-1 | (5)-1 | (5)-1 | (5)-1 | (5)-3 | (5)-1 | (5)-1 | (5)-6 |
| chemical formulas | (5)-2 | (5)-2 | (5)-2 | (5)-2 | (5)-2 | (5)-2 | (5)-4 | (5)-5 | (5)-4 | (5)-4 | (5)-2 | |

TABLE 5-6

| Example No.: | 61 | 62 | 63 | 64 | 65 | 66 | 67 | 68 | 69 | 70 |
|---|---|---|---|---|---|---|---|---|---|---|
| Elastic roller | A | A | A | A | A | A | A | B | C | No |
| Formula-(1) material | H | H | H | H | H | H | H | H | H | H |
| Chemical formula | (1)-1 | (1)-1 | (1)-1 | (1)-1 | (1)-1 | (1)-1 | (1)-1 | (1)-1 | (1)-1 | (1)-1 |
| n1 or n2 or n3 | 12 | 12 | 12 | 12 | 12 | 12 | 12 | 12 | 12 | 12 |
| Number of moles (mmol) | 1.137 | 1.137 | 1.138 | 1.138 | 1.137 | 1.137 | 1.137 | 1.137 | 1.137 | 1.137 |
| Amount (g) | 0.621 | 0.621 | 0.621 | 0.622 | 0.621 | 0.621 | 0.621 | 0.621 | 0.621 | 0.621 |
| Formula-(1) material | No | No | No | No | No | No | No | No | No | No |
| Chemical formula | No | No | No | No | No | No | No | No | No | No |
| n1 or n2 or n3 | — | — | — | — | — | — | — | — | — | — |
| Number of moles (mmol) | — | — | — | — | — | — | — | — | — | — |
| Amount (g) | — | — | — | — | — | — | — | — | — | — |
| Formula-(1) content | 30 | 30 | 30 | 30 | 30 | 30 | 30 | 30 | 30 | 30 |
| (% by mass) | | | | | | | | | | |
| Formula-(2) material | S | T | T | T | U | R | R | R | R | R |
| Chemical formula | (2)-1 | (2)-1 | (2)-1 | (2)-1 | (2)-1 | (2)-1 | (2)-1 | (2)-1 | (2)-1 | (2)-1 |
| m1:p1 or m2:p2 | 82:18 | 90:10 | 90:10 | 90:10 | 74:26 | 74:26 | 74:26 | 74:26 | 74:26 | 74:26 |
| Number of moles (mmol) | 0.584 | 0.448 | 0.448 | 0.409 | 0.724 | 0.692 | 0.692 | 0.724 | 0.724 | 0.724 |
| Amount (g) | 1.051 | 1.075 | 1.076 | 0.982 | 1.013 | 0.968 | 0.968 | 1.013 | 1.013 | 1.013 |
| Ion conducting agent | g. | g. | g. | g. | g. | e. | f. | g. | g. | g. |
| Amount (g) | 0.039 | 0.039 | 0.039 | 0.039 | 0.039 | 0.039 | 0.039 | 0.039 | 0.039 | 0.039 |
| Amount (parts by mass) | 2 | 2 | 2 | 2 | 2 | 2 | 2 | 2 | 2 | 2 |
| Other material | Y | Y | Y | Y | Y | Y | Y | Y | Y | Y |
| Amount (g) | 0.289 | 0.265 | 0.283 | 0.249 | 0.327 | 0.372 | 0.372 | 0.327 | 0.327 | 0.327 |
| Formula-(3) materials, | (3)-6 | (3)-6 | (3)-6 | (3)-6 | (3)-6 | (3)-6 | (3)-6 | (3)-6 | (3)-6 | (3)-6 |
| chemical formulas | (3)-8 | (3)-8 | (3)-8 | (3)-8 | (3)-8 | (3)-7 | (3)-7 | (3)-8 | (3)-8 | (3)-8 |
| | | | | | | (3)-8 | (3)-8 | | | |
| Formula-(4) material, | No | No | No | No | No | No | No | No | No | No |
| chemical formula | | | | | | | | | | |
| Formula-(5) material, | (5)-6 | (5)-6 | (5)-6 | (5)-6 | (5)-6 | (5)-7 | (5)-7 | (5)-6 | (5)-6 | (5)-6 |
| chemical formula | | | | | | | | | | |

TABLE 6

| | Comparative Example No.: | | | | |
|---|---|---|---|---|---|
| | 1 | 2 | 3 | 4 | |
| Elastic roller | A | A | A | A | |
| Formula-(1) material | No | No | D | D | |
| Chemical formula | No | No | (1)-1 | (1)-1 | |
| n1 or n2 or n3 | — | — | 13 | 13 | |
| Number of moles (mmol) | — | — | 0.988 | 0.322 | |
| Amount (g) | — | — | 0.735 | 0.239 | |
| Formula-(1) material | No | No | O | O | |
| Chemical formula | No | No | (1)-1 | (1)-1 | |
| n1 or n2 or n3 | — | — | 2 | 2 | |
| Number of moles (mmol) | — | — | 0.384 | 0.321 | |
| Amount (g) | — | — | 0.057 | 0.048 | |
| Formula-(1) content (% by mass) | 0 | 0 | 30 | 10 | |
| Formula-(2) material | V | W | R | R | V |
| Chemical formula | (2)-1 | (2)-2 | (2)-1 | (2)-1 | (2)-1 |
| m1:p1 or m2:p2 | 74:26 | 74:26 | 74:26 | 74:26 | 74:26 |
| Number of moles (mmol) | 0.5 | 0.5 | 0.835 | 0.322 | 0.322 |
| Amount (g) | 1.9 | 1.9 | 1.169 | 0.451 | 1.223 |

| | | | | |
|---|---|---|---|---|
| Ion conducting agent | a. | a. | h. | a. |
| Amount (g) | 0.039 | 0.039 | 0.039 | 0.039 |
| Amount (parts by mass) | 2 | 2 | 2 | 2 |
| Other material | α. | α. | No | No |
| Amount (g) | 0.060 | 0.060 | — | — |
| Formula-(3) materials, chemical | (3)-1 | (3)-1 | (3)-1 | (3)-1 |
| formulas | | | (3)-2 | (3)-2 |
| Formula-(4) material, chemical | No | No | No | No |
| formula | | | | |
| Formula-(5) material, chemical | (5)-1 | (5)-1 | No | (5)-1 |
| formula | | | | (5)-2 |

TABLE 7-1

| Example No.: | 1 | 2 | 3 | 4 | 5 | 6 | 7 | 8 | 9 | 10 |
|---|---|---|---|---|---|---|---|---|---|---|
| Current of elastic | 20 | 20 | 20 | 20 | 20 | 20 | 20 | 20 | 20 | 20 |
| layer in L/L (mA) | | | | | | | | | | |
| Current of elastic | 22 | 22 | 22 | 22 | 22 | 22 | 22 | 22 | 22 | 22 |
| layer in H/H (mA) | | | | | | | | | | |
| Resistivity of | 5.50E+07 | 1.27E+09 | 8.33E+07 | 5.46E+07 | 1.62E+08 | 1.30E+08 | 4.70E+07 | 4.17E+07 | 2.89E+07 | 1.16E+08 |
| conductive layer | | | | | | | | | | |
| in L/L (Ω · cm) | | | | | | | | | | |
| Resistivity of | 8.56E+05 | 7.99E+06 | 8.01E+05 | 8.99E+05 | 3.81E+06 | 2.19E+06 | 5.63E+05 | 4.54E+05 | 1.77E+05 | 2.55E+06 |
| conductive layer | | | | | | | | | | |
| in H/H (Ω · cm) | | | | | | | | | | |
| Environmental | 1.81 | 2.20 | 2.02 | 1.78 | 1.63 | 1.77 | 1.92 | 1.96 | 2.21 | 1.66 |
| dependence of | | | | | | | | | | |
| resistivity | | | | | | | | | | |
| Conductive layer, | 10 | 10 | 10 | 10 | 10 | 10 | 10 | 10 | 10 | 10 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | A | C | A | A | B | B | A | A | A | A |
| (charging roller) | | | | | | | | | | |
| Streaky images in H/H | B | A | B | B | A | A | B | B | B | A |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 7-2

| Example No.: | 11 | 12 | 13 | 14 | 15 | 16 | 17 | 18 | 19 | 20 |
|---|---|---|---|---|---|---|---|---|---|---|
| Current of elastic | 20 | 20 | 20 | 20 | 20 | 20 | 20 | 20 | 20 | 20 |
| layer in L/L (mA) | | | | | | | | | | |
| Current of elastic | 22 | 22 | 22 | 22 | 22 | 22 | 22 | 22 | 22 | 22 |
| layer in H/H (mA) | | | | | | | | | | |
| Resistivity of | 4.83E+07 | 4.56E+07 | 2.11E+07 | 1.05E+08 | 4.73E+07 | 4.41E+07 | 1.88E+07 | 2.22E+08 | 1.88E+08 | 1.71E+08 |
| conductive layer | | | | | | | | | | |
| in L/L (Ω · cm) | | | | | | | | | | |
| Resistivity of | 9.02E+05 | 8.27E+05 | 3.00E+05 | 2.63E+06 | 9.03E+05 | 8.30E+05 | 3.29E+05 | 3.84E+06 | 4.06E+06 | 4.09E+06 |
| conductive layer | | | | | | | | | | |
| in H/H (Ω · cm) | | | | | | | | | | |
| Environmental | 1.73 | 1.74 | 1.85 | 1.60 | 1.72 | 1.73 | 1.76 | 1.76 | 1.67 | 1.62 |
| dependence of | | | | | | | | | | |
| resistivity | | | | | | | | | | |
| Conductive layer, | 10 | 10 | 10 | 10 | 10 | 10 | 10 | 10 | 10 | 10 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | A | A | A | A | A | A | A | B | B | B |
| (charging roller) | | | | | | | | | | |
| Streaky images in H/H | A | B | B | A | A | B | B | A | A | A |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 7-3

| Example No.: | 21 | 22 | 23 | 24 | 25 | 26 | 27 | 28 | 29 | 30 |
|---|---|---|---|---|---|---|---|---|---|---|
| Current of elastic | 20 | 20 | 20 | 20 | 20 | 20 | 20 | 20 | 20 | 20 |
| layer in L/L (mA) | | | | | | | | | | |
| Current of elastic | 22 | 22 | 22 | 22 | 22 | 22 | 22 | 22 | 22 | 22 |
| layer in H/H (mA) | | | | | | | | | | |
| Resistivity of | 5.04E+08 | 1.30E+08 | 8.99E+07 | 1.56E+08 | 1.28E+08 | 3.56+08 | 1.88E+08 | 5.54E+08 | 1.43E+08 | 9.88E+07 |
| conductive layer | | | | | | | | | | |
| in L/L (Ω · cm) | | | | | | | | | | |
| Resistivity of | 1.82E+07 | 2.17E+06 | 8.46E+05 | 4.13E+06 | 4.17E+06 | 3.76E+06 | 3.93E+06 | 1.75E+07 | 2.08E+06 | 8.13E+05 |
| conductive layer | | | | | | | | | | |
| in H/H (Ω · cm) | | | | | | | | | | |
| Environmental | 1.44 | 1.78 | 2.03 | 1.58 | 1.46 | 1.98 | 1.68 | 1.50 | 1.84 | 2.08 |
| dependence of | | | | | | | | | | |
| resistivity | | | | | | | | | | |
| Conductive layer, | 10 | 10 | 10 | 10 | 10 | 10 | 10 | 10 | 10 | 10 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | C | B | A | A | A | C | B | C | B | A |
| (charging roller) | | | | | | | | | | |
| Streaky images in H/H | A | A | B | A | A | A | A | A | A | B |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 7-4

| Example No.: | 31 | 32 | 33 | 34 | 35 | 36 | 37 | 38 | 39 | 40 |
|---|---|---|---|---|---|---|---|---|---|---|
| Current of elastic | 20 | 20 | 20 | 20 | 20 | 20 | 20 | 20 | 20 | 20 |
| layer in L/L (mA) | | | | | | | | | | |
| Current of elastic | 22 | 22 | 22 | 22 | 22 | 22 | 22 | 22 | 22 | 22 |
| layer in H/H (mA) | | | | | | | | | | |
| Resistivity of | 1.62E+08 | 1.36E+08 | 1.49E+07 | 1.01E+07 | 5.17E+07 | 1.80E+08 | 5.38E+07 | 2.81E+07 | 1.82E+08 | 5.60E+07 |
| conductive layer | | | | | | | | | | |
| in L/L (Ω · cm) | | | | | | | | | | |
| Resistivity of | 4.00E+06 | 4.07E+06 | 2.14E+05 | 1.41E+05 | 8.32E+05 | 3.84E+06 | 8.20E+05 | 1.64E+05 | 3.65E+06 | 8.44E+05 |
| conductive layer | | | | | | | | | | |
| in H/H (Ω · cm) | | | | | | | | | | |
| Environmental | 1.61 | 1.52 | 1.84 | 1.86 | 1.79 | 1.67 | 1.82 | 2.23 | 1.70 | 1.82 |
| dependence of | | | | | | | | | | |
| resistivity | | | | | | | | | | |
| Conductive layer, | 10 | 10 | 10 | 10 | 10 | 10 | 10 | 10 | 10 | 10 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | B | B | A | A | A | B | A | A | B | A |
| (charging roller) | | | | | | | | | | |
| Streaky images in H/H | A | A | B | C | B | A | B | B | A | B |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 7-5

| Example No.: | 41 | 42 | 43 | 44 | 45 | 46 | 47 | 48 | 49 | 50 |
|---|---|---|---|---|---|---|---|---|---|---|
| Current of elastic | 20 | 20 | 20 | 20 | 20 | 20 | 20 | 0.36 | 23 | — |
| layer in L/L (mA) | | | | | | | | | | |
| Current of elastic | 22 | 22 | 22 | 22 | 22 | 22 | 22 | 13 | 24 | — |
| layer in H/H (mA) | | | | | | | | | | |
| Resistivity of | 1.91E+08 | 5.11E+07 | 1.73E+08 | 5.70E+07 | 2.27E+08 | 5.63E+07 | 2.19E+08 | 8.21E+07 | 5.44E+07 | 7.55E+07 |
| conductive layer | | | | | | | | | | |
| in L/L (Ω · cm) | | | | | | | | | | |
| Resistivity of | 3.73E+06 | 8.04E+05 | 3.54E+06 | 8.29E+05 | 3.81E+06 | 8.21E+05 | 3.47E+06 | 1.28E+06 | 8.51E+05 | 1.11E+06 |
| conductive layer | | | | | | | | | | |
| in H/H (Ω · cm) | | | | | | | | | | |
| Environmental | 1.71 | 1.80 | 1.69 | 1.84 | 1.78 | 1.84 | 1.80 | 1.81 | 1.81 | 1.83 |
| dependence of | | | | | | | | | | |
| resistivity | | | | | | | | | | |
| Conductive layer, | 10 | 10 | 10 | 10 | 10 | 10 | 10 | 10 | 10 | 500 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | B | A | B | A | B | A | B | A | — | A |
| (charging roller) | | | | | | | | | | |
| Streaky images in H/H | A | B | A | B | A | B | A | A | B | A |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 7-6

| Example No.: | 51 | 52 | 53 | 54 | 55 | 56 | 57 | 58 | 59 | 60 |
|---|---|---|---|---|---|---|---|---|---|---|
| Current of elastic | 20 | 20 | 20 | 20 | 20 | 20 | 20 | 20 | 20 | 20 |
| layer in L/L (mA) | | | | | | | | | | |
| Current of elastic | 22 | 22 | 22 | 22 | 22 | 22 | 22 | 22 | 22 | 22 |
| layer in H/H (mA) | | | | | | | | | | |
| Resistivity of | 5.14E+07 | 6.63E+07 | 5.50E+07 | 5.50E+07 | 1.36E+08 | 3.60E+08 | 6.41E+07 | 1.31E+08 | 2.10E+08 | 5.61E+07 |
| conductive layer | | | | | | | | | | |
| in L/L (Ω · cm) | | | | | | | | | | |
| Resistivity of | 7.94E+05 | 9.86E+05 | 8.56E+05 | 8.56E+05 | 2.53E+06 | 4.74E+06 | 1.47E+06 | 2.50E+06 | 8.10E+05 | 8.53E+05 |
| conductive layer | | | | | | | | | | |
| in H/H (Ω · cm) | | | | | | | | | | |
| Environmental | 1.81 | 1.83 | 1.81 | 1.81 | 1.73 | 1.88 | 1.64 | 1.72 | 2.41 | 1.82 |
| dependence of | | | | | | | | | | |
| resistivity | | | | | | | | | | |
| Conductive layer, | 2 | 100 | 10 | 10 | 10 | 10 | 10 | 10 | 10 | 10 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | A | A | A | — | B | C | A | B | B | A |
| (charging roller) | | | | | | | | | | |
| Streaky images in H/H | B | A | B | — | A | A | A | A | B | B |
| (common to | | | | | | | | | | |
| charging roller & | | | | | | | | | | |
| developing roller) | | | | | | | | | | |
| Fog images in L/L | — | — | — | — | — | — | — | — | — | — |
| (developing roller) | | | | | | | | | | |
| Image evaluation in | — | — | — | A | — | — | — | — | — | — |
| L/L (transfer roller) | | | | | | | | | | |
| Image evaluation in | — | — | — | A | — | — | — | — | — | — |
| H/H (transfer roller) | | | | | | | | | | |

TABLE 7-7

| Example No.: | 61 | 62 | 63 | 64 | 65 | 66 | 67 | 68 | 69 | 70 |
|---|---|---|---|---|---|---|---|---|---|---|
| Current of elastic | 20 | 20 | 20 | 20 | 20 | 20 | 20 | 0.36 | 23 | — |
| layer in L/L (mA) | | | | | | | | | | |
| Current of elastic | 22 | 22 | 22 | 22 | 22 | 22 | 22 | 13 | 24 | — |
| layer in H/H (mA) | | | | | | | | | | |
| Resistivity of | 4.90E+07 | 4.80E+07 | 1.55E+07 | 1.08E+07 | 5.60E+07 | 5.77E+07 | 5.70E+07 | 8.30E+07 | 5.60E+07 | 5.45E+07 |
| conductive layer | | | | | | | | | | |
| in L/L (Ω · cm) | | | | | | | | | | |
| Resistivity of | 8.97E+05 | 8.94E+05 | 2.11E+05 | 1.38E+05 | 8.48E+05 | 8.24E+05 | 8.15E+05 | 1.27E+06 | 8.45E+05 | 8.33E+05 |
| conductive layer | | | | | | | | | | |
| in H/H (Ω · cm) | | | | | | | | | | |
| Environmental | 1.74 | 1.73 | 1.87 | 1.89 | 1.82 | 1.85 | 1.84 | 1.82 | 1.82 | 1.82 |
| dependence of | | | | | | | | | | |
| resistivity | | | | | | | | | | |
| Conductive layer, | 10 | 10 | 10 | 10 | 10 | 10 | 10 | 10 | 10 | 500 |
| layer thickness (μm) | | | | | | | | | | |
| Domain | No | No | No | No | No | No | No | No | No | No |
| Evaluation on | A | A | A | A | A | A | A | A | A | A |
| bleeding | | | | | | | | | | |
| Streaky images in L/L | A | A | A | A | A | A | A | A | — | A |
| (charging roller) | | | | | | | | | | |
| Streaky images in H/H | B | B | B | C | B | B | B | A | B | B |
| (common to | | | | | | | | | | |
| charging roller & | | | | | | | | | | |
| developing roller) | | | | | | | | | | |
| Fog images in L/L | — | — | — | — | — | — | — | — | A | — |
| (developing roller) | | | | | | | | | | |
| Image evaluation in | — | — | — | — | — | — | — | — | — | — |
| L/L (transfer roller) | | | | | | | | | | |
| Image evaluation in | — | — | — | — | — | — | — | — | — | — |
| H/H (transfer roller) | | | | | | | | | | |

TABLE 8

| | Comparative Example No.: | | | |
|---|---|---|---|---|
| | 1 | 2 | 3 | 4 |
| Current of elastic layer | 20 | 20 | 20 | 20 |
| in L/L (mA) | | | | |
| Current of elastic layer | 22 | 22 | 22 | 22 |
| in H/H (mA) | | | | |
| Resistivity of | 7.82E+08 | 7.90E+08 | 6.94E+07 | 6.44E+08 |
| conductive layer in L/L | | | | |
| (Ω · cm) | | | | |
| Resistivity of | 5.85E+06 | 5.94E+06 | 8.88E+05 | 4.54E+06 |
| conductive layer in H/H | | | | |
| (Ω · cm) | | | | |
| Environmental | 2.13 | 2.12 | 1.89 | 2.15 |
| dependence of resistivity | | | | |
| Conductive layer, | 10 | 10 | 10 | 10 |
| layer thickness (μm) | | | | |
| Domain | No | No | No | Yes |
| Evaluation on bleeding | A | A | C | A |
| Streaky images in L/L | D | D | A | D |
| (charging roller) | | | | |
| Streaky images in H/H | A | A | B | A |
| (common to charging | | | | |
| roller & developing | | | | |
| roller) | | | | |
| Fog images in L/L | — | — | — | — |
| (developing roller) | | | | |
| Image evaluation in L/L | — | — | — | — |
| (transfer roller) | | | | |
| Image evaluation in H/H | — | — | — | — |
| (transfer roller) | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-284451, filed Dec. 26, 2011, which is hereby incorporated by reference herein in its entirety.

1. An electrically conductive member for electrophotography comprising:
an electrically conductive mandrel; and
an electrically conductive layer provided on the peripheral surface thereof, wherein:
the electrically conductive layer contains
a binder resin having as an ion exchange group a sulfo group or a quaternary ammonium salt group in the molecule thereof, and
an ion with a polarity opposite to that of the ion exchange group; and wherein:
the binder resin has
any structure selected from the group consisting of structures represented by formulas (1)-1 to (1)-3, and
any structure selected from the group consisting of structures represented by formulas (2)-1 and (2)-2, and
the binder resin has a molecular structure that prevents any matrix-domain structure from being formed in the electrically conductive layer: 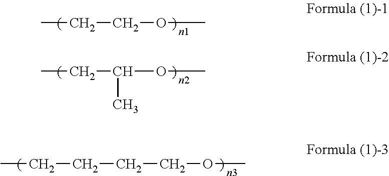
where, in the formula (1)-1, n1 represents an integer of 1 or more; in the formula (1)-2, n2 represents an integer of 1 or more; and, in the formula (1)-3, n3 represents an integer of 1 or more; and 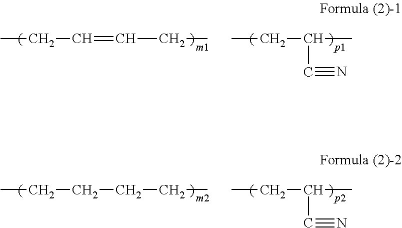
where, in the formula (2)-1, m1 and p1 each independently represent an integer of 1 or more, and the ratio of m1 to p1, m1:p1, is from 74:26 to 90:10; and, in the formula (2)-2, m2 and p2 each independently represent an integer of 1 or more, and the ratio of m2 to p2, m2:p2, is from 74:26 to 90:10.

2. The electrically conductive member according to claim 1, wherein the values of n1, n2 and n3 are each independently from 4 to 22.

3. The electrically conductive member according to claim 1, wherein the binder resin contains a structure in which
any structure selected from the group consisting of structures represented by the formulas (1)-1 to (1)-3, and
any structure selected from the group consisting of structures represented by the formulas (2)-1 and (2)-2 stand linked with at least one linking group selected from the group consisting of structures represented by the following formulas (3)-1 to (3)-8:

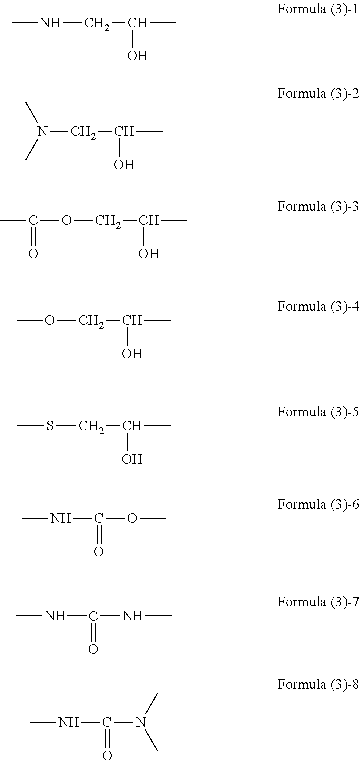

4. The electrically conductive member according to claim 1, wherein the binder resin contains a structure in which
any structure selected from the group consisting of structures represented by the formulas (1)-1 to (1)-3, and any structure selected from the group consisting of structures represented by the formulas (2)-1 and (2)-2 stand linked with a linking group having a structure represented by the following formula (4): 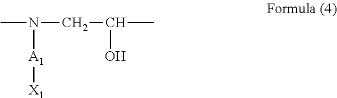
where, in the formula (4), A₁ represents a divalent organic group, and X₁ represents an ion exchange group.

5. The electrically conductive member according to claim 1, wherein the binder resin contains at its molecular terminal at least one structure selected from the group consisting of structures represented by the following formulas (5)-1 to (5)-7: 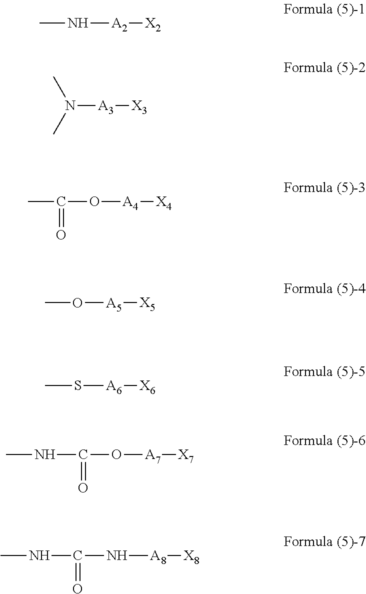
where, in the formulas (5)-1 to (5)-7, A₂ to A₈ each represent a divalent organic group, and X₂ to X₈ each represent an ion exchange group.

6. The electrically conductive member according to claim 1, wherein the structure represented by the formula (1)-1 is in a content of 30% by mass or less of the binder resin.

7. The electrically conductive member according to claim 1, wherein the binder resin is an epoxy resin obtained by allowing an epoxy-modified ethylene oxide to react with an amino-modified liquid-state NBR.

8. The electrically conductive member according to claim 1, wherein the ion exchange group is a quaternary ammonium salt group and the ion with a polarity opposite to that of the former is a sulfonyl imide ion.

9. A process cartridge which is so constituted as to be detachably mountable to the main body of an electrophotographic apparatus, and comprises the conductive member according to claim 1.

10. An electrophotographic apparatus which comprises the conductive member according to claim 1.
